(19) United States
(12) Patent Application Publication
(10) Pub. No.: US 2017/0264558 A1
(43) Pub. Date: Sep. 14, 2017

(54) METHOD OF ANALYZING PACKETS AND ANALYSIS DEVICE

(71) Applicant: FUJITSU LIMITED, Kawasaki-shi (JP)

(72) Inventors: Junichi Higuchi, Kawasaki (JP); Yasuhiko Kanemasa, Kawasaki (JP)

(73) Assignee: FUJITSU LIMITED, Kawasaki-shi (JP)

(21) Appl. No.: 15/388,414

(22) Filed: Dec. 22, 2016

(30) Foreign Application Priority Data
Mar. 8, 2016 (JP) 2016-044660

(51) Int. Cl. H04L 12/825; H04L 1/18; H04L 12/26

(52) U.S. Cl. CPC H04L 47/25; H04L 43/0829; H04L 1/189

(57) ABSTRACT

A method of analyzing packets performed by a computer, the method includes, for each of a plurality of data transmission apparatuses and for each of a plurality of periods, specifying a number of packets transmitted from each of a plurality of data transmission apparatuses, specifying a number of times that a transmission interval of the packets is equal to or larger than a first value, specifying a ratio of the number of times to the number of packets, specifying amount of increase of the ratio for a period immediately before each of the plurality of periods, specifying a period in which the number of the data transmission apparatuses of which the amount of increase is equal to or larger than a second value is equal to or larger than a third value among the plurality of periods, and outputting first information indicating the specified period.

### CROSS-REFERENCE TO RELATED APPLICATION

This application is based upon and claims the benefit of priority of the prior Japanese Patent Application No. 2016-044660, filed on Mar. 8, 2016, the entire contents of which are incorporated herein by reference.

### FIELD

The embodiments discussed herein are related to a method of analyzing packets and an analysis device.

### BACKGROUND

With the development of information-oriented society, opportunities in which packets are transmitted and received between different information terminals have been increasing. For example, information terminals, such as a computer and a smartphone, are coupled to a network and a cloud service is used.

In a case where packets are transmitted and received via a network, some packets may be missing on the network (also referred to as packet loss) due to some reasons. Accordingly, various packet analysis apparatuses are proposed that acquire packets flowing through a network and analyze a packet loss situation. Japanese Laid-open Patent Publication No. 2012-186772, Japanese Laid-open Patent Publication No. 2010-16722, Japanese Laid-open Patent Publication No. 2010-109499, and Japanese Laid-open Patent Publication No. 2013-150291 are examples of related-art documents.

### SUMMARY

According to an aspect of the invention, a method of analyzing packets performed by a computer, the method includes for each of a plurality of data transmission apparatuses and for each of a plurality of periods, specifying a number of packets transmitted from each of a plurality of data transmission apparatuses, for each of the plurality of data transmission apparatuses and for each of the plurality of periods, specifying a number of times that a transmission interval of the packets is equal to or larger than a first value, for each of the plurality of data transmission apparatuses and for each of the plurality of periods, specifying a ratio of the number of times to the number of packets, for each of the plurality of data transmission apparatuses and for each of the plurality of periods, specifying amount of increase of the ratio for a period immediately before each of the plurality of periods, specifying a period in which the number of the data transmission apparatuses of which the amount of increase is equal to or larger than a second value is equal to or larger than a third value among the plurality of periods, and outputting first information indicating the specified period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network;

FIG. 2 is a diagram illustrating an example of coupling of switch apparatuses;

FIG. 3 is a diagram illustrating an example of a configuration of a packet analysis apparatus according to a first embodiment and a second embodiment;

FIG. 4 is a diagram illustrating an example of a configuration in which the packet analysis apparatus is realized by a computer;

FIG. 5A is a flowchart illustrating an example of flow of a packet analyzing process;

FIG. 5B is a flowchart illustrating an example of the flow of the packet analyzing process;

FIG. 6 is a diagram illustrating an example of a session management table;

FIG. 7 is a diagram illustrating an example of a packet count table;

FIG. 8 is a diagram illustrating an example of the packet count table to which initialized data is added;

FIG. 9 is a diagram illustrating an example of the packet count table to which the initialized data is added;

FIG. 10 is a diagram illustrating an example of packet interval increase detection data;

FIG. 11A is a flowchart illustrating an example of flow of a packet loss determining process according to the first embodiment;

FIG. 11B is a flowchart illustrating an example of the flow of the packet loss determining process according to the first embodiment;

FIG. 12 is a diagram illustrating an example of an increase amount management table;

FIG. 13 is a diagram illustrating an example of a packet loss count table;

FIG. 14 is a diagram illustrating an example of an address conversion table;

FIG. 15 is a diagram illustrating an example of packet loss notification data;

FIG. 16 is a diagram illustrating an example of a screen which is displayed based on the packet loss notification data;

FIG. 17A is a flowchart illustrating an example of flow of a packet loss determining process according to the second embodiment;

FIG. 17B is a flowchart illustrating an example of the flow of the packet loss determining process according to the second embodiment;

FIG. 18 is a diagram illustrating an example of a configuration of a packet analysis apparatus according to a third embodiment;

FIG. 19 is a flowchart illustrating an example of flow of a packet loss determining process according to the third embodiment;

FIG. 20 is a diagram illustrating an example of a configuration of a packet analysis apparatus according to a fourth embodiment;

FIG. 21A is a flowchart illustrating an example of flow of a packet loss determining process according to the fourth embodiment; and

FIG. 21B is a flowchart illustrating an example of the flow of the packet loss determining process according to the fourth embodiment.

### DESCRIPTION OF EMBODIMENTS

A packet analysis apparatus is inserted into a network that couples, for example, a terminal (hereinafter, referred to as a transmission terminal) which transmits packets to a terminal (hereinafter, referred to as a reception terminal) which is a transmission destination of the packets, and monitors the packets which flow through the network.

For example, in a case where a packet in conformity to a transmission control protocol/internet protocol (TCP/IP) protocol is missing between the packet analysis apparatus and the reception terminal, the packet analysis apparatus detects packet loss using duplication of a sequence number of a TCP header.

In contrast, in a case where the packet in conformity to the TCP/IP protocol is missing between the packet analysis apparatus and the transmission terminal, a missing packet retransmission process is performed by the transmission terminal before the packet is received by the packet analysis apparatus.

In this case, the transmission terminal determines whether or not the packet retransmission process is demanded in accordance with existence/non-existence of an acknowledge (ACK) for the transmitted packet from the reception terminal. In a case where ACK is not received within a certain period, the transmission terminal retransmits the transmitted packet. Accordingly, in a packet analysis apparatus according to the related art, for example, if a packet reception interval in the same session is equal to or longer than the certain period, there is a case where it is determined that packet loss has occurred between the packet analysis apparatus and the transmission terminal.

However, there is a case where the transmission terminal divides data into a plurality of packets which have packet lengths as desired, and sequentially transmits the plurality of packets to the reception terminal, similarly to, for example, chunk format encoding in a hypertext transfer protocol (HTTP). In this case, the transmission terminal transmits the packets to the reception terminal while adjusting a packet transmission interval. Accordingly, the packet transmission interval may be longer than the certain period depending on a situation, and thus a situation occurs in which the packet analysis apparatus mistakenly determines that packet loss has occurred although packet loss has not occurred between the packet analysis apparatus and the transmission terminal.

In addition, in a case where packet arrival is delayed more than the certain period due to increase in the amount of traffic in the network and a relay process by a network apparatus, such as the switch apparatus, which is coupled to the network, there is a case where the packet analysis apparatus mistakenly determines that packet loss has occurred.

Hereinafter, an example of an embodiment of a disclosed technology will be described in detail with reference to the accompanying drawings. Meanwhile, hereinafter, the same reference symbols are attached to components and processes which perform the same operations throughout the whole drawings, and the duplicate description thereof is appropriately omitted.

### First Embodiment

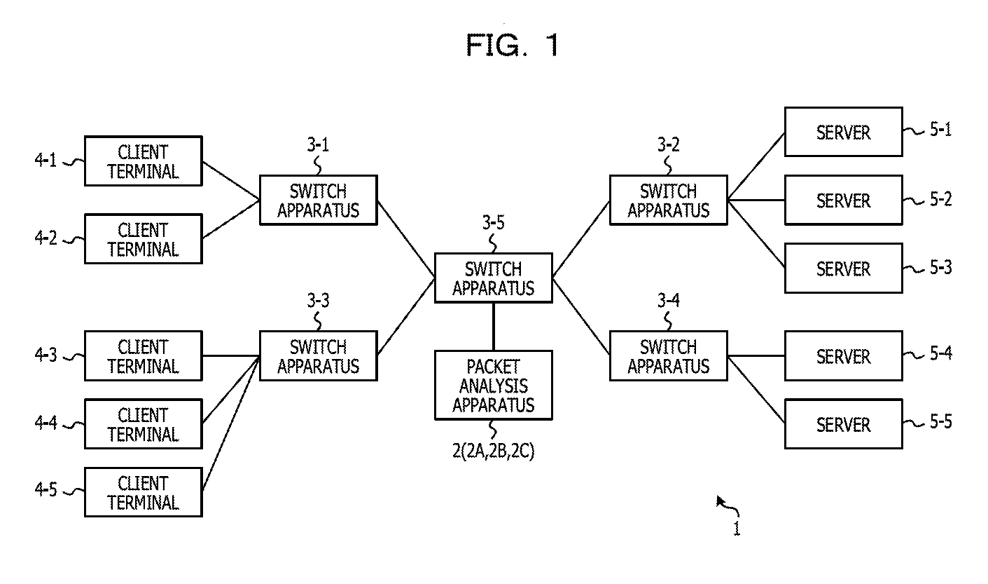

A network 1 illustrated in FIG. 1 includes a packet analysis apparatus 2, switch apparatuses 3-1 to 3-5, client terminals 4-1 to 4-5, and servers 5-1 to 5-5.

Each of the client terminals 4-1 and 4-2 is coupled to the switch apparatus 3-1, and the switch apparatus 3-1 is coupled to the switch apparatus 3-5. In addition, each of the client terminals 4-3, 4-4, and 4-5 is coupled to the switch apparatus 3-3, and the switch apparatus 3-3 is coupled to the switch apparatus 3-5.

In contrast, each of the servers 5-1, 5-2, and 5-3 is coupled to the switch apparatus 3-2, and the switch apparatus 3-2 is coupled to the switch apparatus 3-5. In addition, each of the servers 5-4 and 5-5 is coupled to the switch apparatus 3-4, and the switch apparatus 3-4 is coupled to the switch apparatus 3-5. Furthermore, the packet analysis apparatus 2 is coupled to the switch apparatus 3-5.

Meanwhile, hereinafter, in a case where it is not demanded that the respective switch apparatuses 3-1 to 3-5 are separately described, the switch apparatuses 3-1 to 3-5 are collectively indicated as a “switch apparatus 3”. Similarly, the client terminals 4-1 to 4-5 are indicated as a “client terminal 4” and the servers 5-1 to 5-5 are indicated as a “server 5”. Meanwhile, FIG. 1 illustrates an example of the network 1, and the example of the network 1 is not limited thereto.

The client terminal 4 receives the packets from the designated server 5 through the switch apparatus 3. For example, in a case where the client terminal 4-1 receives packets from the server 5-1, the packets arrive at the client terminal 4-1 through the server 5-1, the switch apparatus 3-2, the switch apparatus 3-5, and the switch apparatus 3-1.

Accordingly, in the above-described situation, the server 5 is an example of the transmission terminal, and the client terminal 4 is an example of the reception terminal.

In contrast, in the network 1, there is a case where, for example, the client terminal 4 transmits to the server 5 a telegraphic message which demands packets. In this case, the client terminal 4 is the transmission terminal, and the server 5 is the reception terminal.

As described above, in the network 1, the transmission terminal and the reception terminal are interchanged depending on a situation. For convenience of explanation, here, an operation of the packet analysis apparatus 2 will be described using an example in which the client terminal 4 receives packets from the designated server 5. However, the server 5 may receive packets which are transmitted by the client terminal 4.

Meanwhile, in the network 1, the switch apparatus 3 is an example of the network apparatus that relays the packets which are transmitted from the server 5, and the network apparatus is not limited to the switch apparatus 3. For example, the switch apparatus 3 may be replaced by another network apparatus, such as a router, as desired.

In addition, a communication line, which respectively couples the client terminal 4 with the switch apparatus 3, the server 5 with the switch apparatus 3, the packet analysis apparatus 2 with the switch apparatus 3, and both the switch apparatuses 3, is not limited to a wired line. The communication line may be a wireless line or the mixture of the wired line and the wireless line.

The packet analysis apparatus 2 monitors the packets that pass through the switch apparatus 3-5, which is a coupling destination of the packet analysis apparatus 2, for each session in time series, and determines whether or not packets are missing in the network 1, that is, determines whether or not packet loss has occurred.

Here, the session is a one-to-one logical communication path which is established between the specific server 5 and the specific client terminal 4.

In the network 1, all of the packets, which are transmitted from the server 5, pass through the switch apparatus 3-5 and arrive at the client terminal 4. Therefore, in order to monitor the whole packets in the network 1, it is preferable that the packet analysis apparatus 2 is coupled to the switch apparatus 3-5.

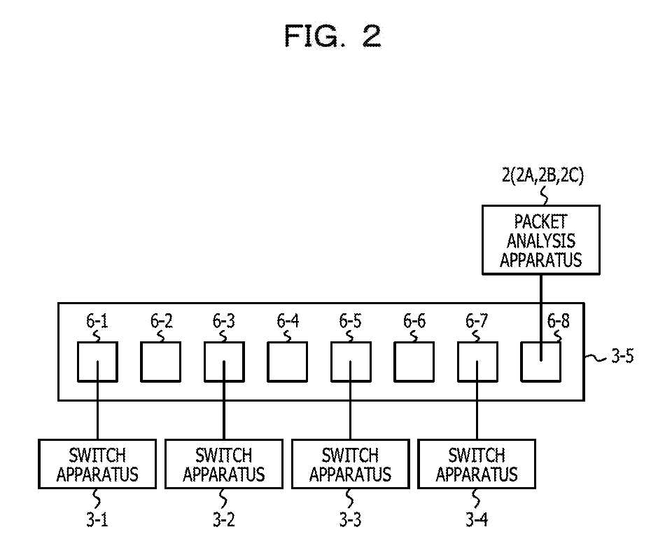

Accordingly, as illustrated in FIG. 2, the switch apparatuses 3-1 to 3-4 and the packet analysis apparatus 2 are coupled to, for example, the switch apparatus 3-5 which includes ports 6-1 to 6-8 in order to couple various apparatuses included in the network 1.

For example, in a case where packets on the communication line, which couples the switch apparatus 3-1 to the switch apparatus 3-2, are monitored using the packet analysis apparatus 2, copies of the packets, which are monitoring targets and flow through the communication line, are also output from the port 6-8 if a mirroring function of the switch apparatus 3-5 is appropriately set. As described above, in the packet analysis apparatus 2, the communication line, in which transmission and reception of the packets are monitored, is selected by selecting a port to be monitored using the mirroring function of the switch apparatus 3.

In the network 1, a connection-type protocol in which ACKs of packets are performed between the server 5 and the client terminal 4, specifically, for example, TCP/IP is used as a packet communication protocol.

Accordingly, in a case where the client terminal 4 receives the packets, which are transmitted from the server 5, the client terminal 4 transmits ACKs toward the server 5, which is a transmission source of the packets, and notifies that the packets are received, to the server 5 which is the transmission source of the packets. In a case where the server 5, which is the transmission source of the packets, receives ACKs from the client terminal 4, the server 5 determines that the packets are received by the client terminal 4, which is a packet demand source, and the process proceeds to a subsequent process.

However, for example, in a case where packets are missing in some locations in the network 1 and the packets are not delivered to the client terminal 4, ACKs from the client terminal 4 are not delivered to the server 5 which is the transmission source of the packets. Accordingly, a retransmission timer of the server 5 which is the transmission source of the packets is timed out, the server 5 retransmits packets, which have the same content as the missing packets, toward the client terminal 4 which is the demand source of the packets.

Accordingly, if packet loss has occurred between the switch apparatus 3-5, which is a coupling destination of the packet analysis apparatus 2, and the reception terminal, it is possible for the packet analysis apparatus 2 to determine whether or not packet loss has occurred based on, for example, duplication of sequence numbers of the packets. Specifically, in a case where a packet that has the same sequence number as a sequence number included in a TCP header of a packet acquired last time is again recognized in the same session, it is possible for the packet analysis apparatus 2 to determine that the packet loss has occurred.

However, as described above, in a case where packet loss has occurred between the switch apparatus 3-5, which is the coupling destination of the packet analysis apparatus 2, and the transmission terminal, it is difficult to determine whether or not packet loss has occurred based on the sequence numbers of the packets.

Hereinafter, a method of determining in the packet analysis apparatus 2 whether or not packet loss has occurred between the switch apparatus 3-5, which is the coupling destination of the packet analysis apparatus 2, and the transmission terminal will be described.

Hereinafter, a portion of the communication line between the switch apparatus 3-5, which is the coupling destination of the packet analysis apparatus 2, and the transmission terminal may be referred to as “upstream of the packet analysis apparatus 2. In addition, a portion of the communication line between the switch apparatus 3-5, which is the coupling destination of the packet analysis apparatus 2, and the reception terminal may be referred to as “downstream of the packet analysis apparatus 2”.

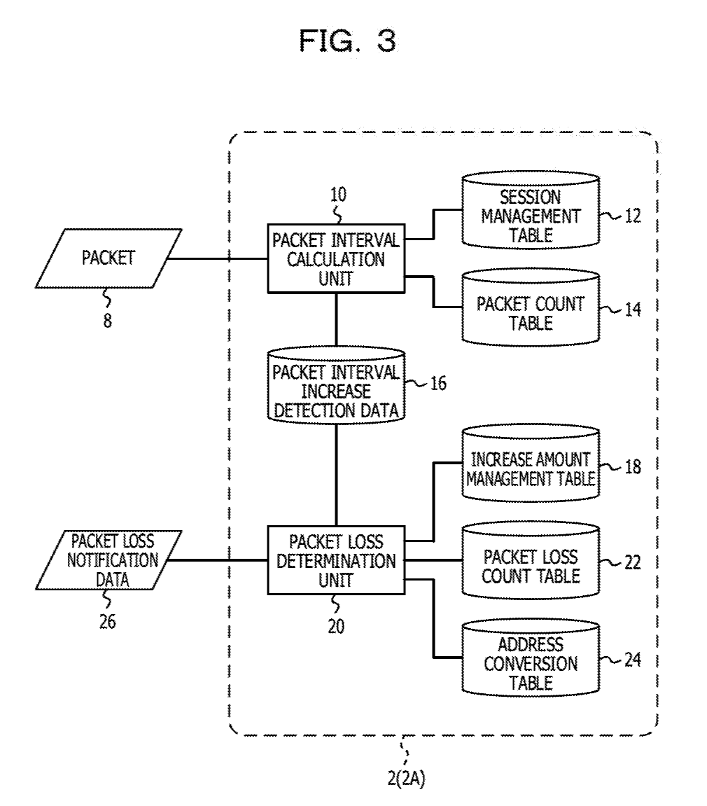

As illustrated in FIG. 3, the packet analysis apparatus 2 includes a packet interval calculation unit 10, a session management table 12, a packet count table 14, and a packet interval increase detection data 16. Furthermore, the packet analysis apparatus 2 includes an increase amount management table 18, a packet loss determination unit 20, a packet loss count table 22, and an address conversion table 24.

The packet interval calculation unit 10 acquires a packet 8, which is the monitoring target, on the communication line in the switch apparatus 3-5, and generates the session management table 12. Here, the session management table 12 is a management table in which IP addresses or the like of the transmission terminal and the reception terminal are recorded for each session.

In addition, the packet interval calculation unit 10 calculates a packet interval which indicates a time interval between consecutive packets in each communication direction which are transmitted from each transmission terminal in a certain period. Furthermore, the packet interval calculation unit 10 records the number of times that the packet interval is equal to or longer than a predetermined period, together with the number of times that the packet is received, in the packet count table 14 for each certain period. Meanwhile, the communication direction will be described later in detail. In addition, the packet interval is an example of the transmission interval between packets of the disclosed technology.

Furthermore, the packet interval calculation unit 10 calculates a ratio of the number of times in which the packet interval is equal to or longer than the predetermined period to the number of times that the packet which is transmitted from the transmission terminal is received for each certain period based on the packet count table 14 for each transmission terminal. Furthermore, the packet interval calculation unit 10 outputs the above-described ratio (hereinafter, referred to as a detection rate r_{d}) which is calculated for each certain period and for each transmission terminal as the packet interval increase detection data 16.

In contrast, the packet loss determination unit 20 acquires the packet interval increase detection data 16 which is output by the packet interval calculation unit 10, calculates the amount of increase in the detection rate r_{d} for an immediately-before certain period for each transmission terminal, and records the calculated amount of increase in the detection rate r_{d} in the increase amount management table 18.

In addition, the packet loss determination unit 20 sets an increase amount threshold to be compared with the amount of increase in the latest detection rate r_{d} for each transmission terminal based on the amount of increase in a past detection rate r_{d} which is stored in the increase amount management table 18. Furthermore, the packet loss determination unit 20 determines whether or not the amount of increase in the detection rate r_{d} is equal to or larger than the increase amount threshold for each certain period and for each transmission terminal, and records a result of determination in the packet loss count table 22.

Furthermore, the packet loss determination unit 20 refers to the packet loss count table 22, and determines whether or not packet loss has occurred upstream of the packet analysis apparatus 2 based on the number of transmission terminals in which the amount of increase in the detection rate r_{d} is equal to or larger than the increase amount threshold.

Furthermore, the packet loss determination unit 20 generates the packet loss notification data 26 which indicates whether or not packet loss has occurred upstream of the packet analysis apparatus 2 for each certain period and for each transmission terminal based on the result of determination. In this case, the packet loss determination unit 20 converts, for example, an IP address of the transmission terminal into an apparatus name, which is assigned to the transmission terminal in advance, with reference to the address conversion table 24, and generates the packet loss notification data 26. Furthermore, the packet loss determination unit 20 outputs the generated packet loss notification data 26.

Meanwhile, the session management table 12, the packet count table 14, the packet interval increase detection data 16, the increase amount management table 18, the packet loss count table 22, the address conversion table 24, and the packet loss notification data 26 will be described in detail later.

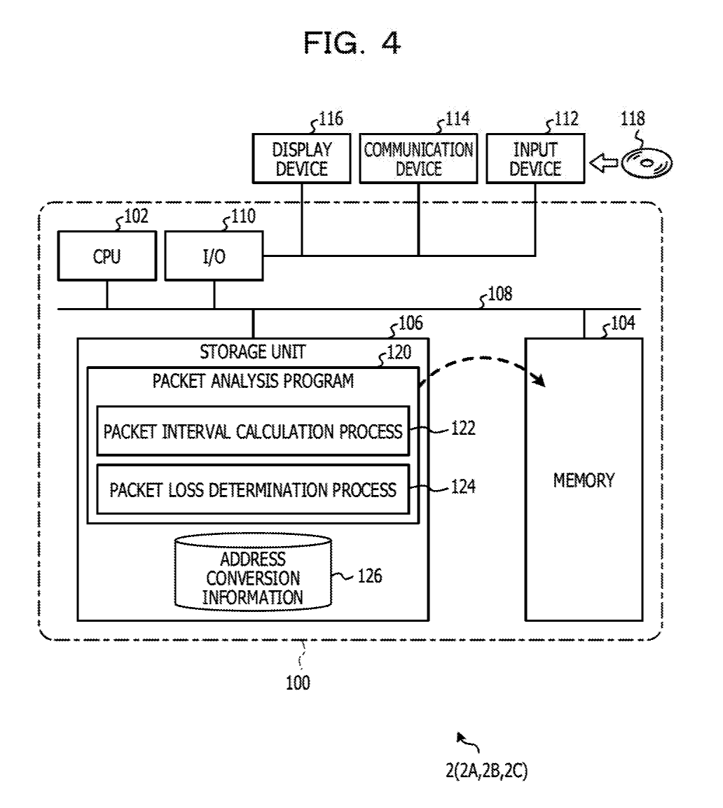

A computer 100 illustrated in FIG. 4 includes a CPU 102, a memory 104, and a non-volatile storage unit 106. The CPU 102, the memory 104, and the non-volatile storage unit 106 are coupled to each other through a bus 108. In addition, the computer 100 includes an input/output (I/O) 110 that couples an input device 112, a communication device 114, and a display device 116 to the computer 100. The I/O 110 is coupled to the bus 108.

Here, the input device 112 includes, for example, an input unit such as a keyboard and a mouse. In addition, the input device 112 includes a reading unit that reads a program or the like which is recorded in, for example, a recording medium 118, such as a compact disc (CD), a digital versatile disk (DVD), or a memory card.

The communication device 114 includes, for example, a communication protocol (for example, the TCP/IP protocol) in order to receive the packet 8 from the switch apparatus 3, and receives the packet 8 from the switch apparatus 3. Furthermore, the communication device 114 outputs the received packet 8 to the computer 100 through the I/O 110.

The display device 116 displays, for example, an image, which is generated by the computer 100 based on the packet loss notification data 26, on a screen.

In addition, it is possible to realize the storage unit 106 using a flash memory, a hard disk drive (HDD), or the like.

Meanwhile, in an example of FIG. 4, the input device 112, the communication device 114, and the display device 116 are illustrated as devices which are independent from the computer 100. However, the embodiment is not limited thereto, and the input device 112, the communication device 114, and the display device 116 may be built in the computer 100.

The storage unit 106 stores a packet analysis program 120 which causes the computer 100 to function as the packet analysis apparatus 2 illustrated in FIG. 3, and address conversion information 126 that includes information in order to generate the address conversion table 24. The packet analysis program 120, which is stored in the storage unit 106, includes a packet interval calculation process 122 and a packet loss determination process 124.

The CPU 102 causes the computer 100 to function as the packet analysis apparatus 2 illustrated in FIG. 3 by reading the packet analysis program 120 from the storage unit 106 and deploying the packet analysis program 120 in the memory 104 and by executing each process included in the packet analysis program 120.

That is, the CPU 102 executes the packet interval calculation process 122 and thereby the computer 100 functions as the packet interval calculation unit 10 illustrated in FIG. 3. In addition, the CPU 102 executes the packet loss determination process 124 and thereby the computer 100 functions as the packet loss determination unit 20 illustrated in FIG. 3.

In addition, the CPU 102 deploys the address conversion information 126 in the memory 104, and generates the address conversion table 24 in the memory 104.

Meanwhile, it is possible to realize the computer 100 using, for example, a semiconductor integrated circuit, more specifically, an application specific integrated circuit (ASIC) or the like.

In addition, the CPU 102 of the computer 100 according to the embodiment includes a calendar function which manages date and time. It is possible for the packet analysis program 120 to acquire date and time information from the CPU 102 using a predetermined application programming interface (API).

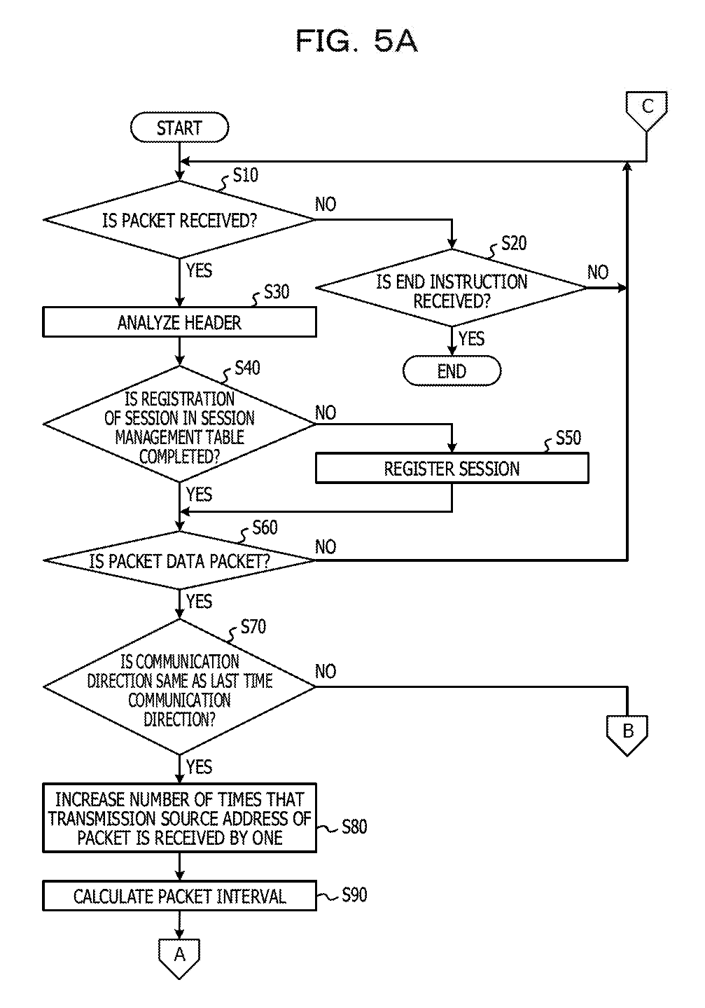

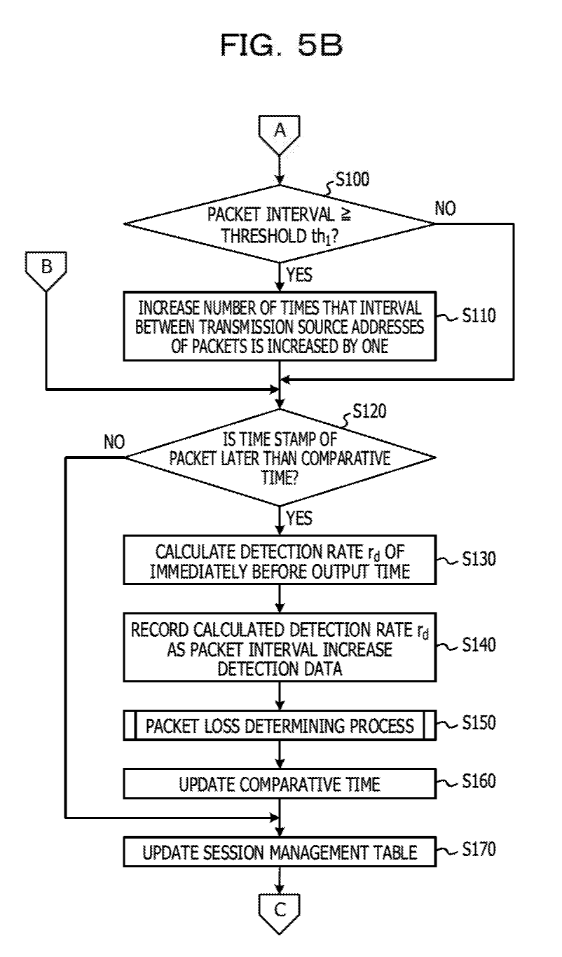

Next, an operation of the packet analysis apparatus 2 according to the first embodiment will be described. For example, in a case where the packet analysis apparatus 2 receives an analysis start instruction from a user through the input device 112, the packet analysis apparatus 2 performs a packet analyzing process illustrated in FIGS. 5A and 5B. In this case, it is assumed that a value of a comparative time, which will be described later, is initialized in advance as, for example, 12 a.m. (hereinafter, there is a case of being described as “0:00”).

Furthermore, hereinafter, the packet interval calculation unit 10 is described as the calculation unit 10, and the packet loss determination unit 20 is described as the determination unit 20. In addition, there is a case where FIGS. 5A and 5B are collectively described as FIG. 5.

First, in step S10 of FIG. 5A, the calculation unit 10 determines whether or not the packet 8, which is the monitoring target, on the communication line is received. In a case where the packet 8 is not received, the process proceeds to step S20.

In step S20, the calculation unit 10 determines whether or not a packet analyzing process end instruction is received from the user through the input device 112. In a case where the end instruction is received, a packet analyzing process illustrated in FIG. 5 is ended.

In contrast, in a case where the packet analyzing process end instruction is not received, the process returns to step S10. Furthermore, the packet 8, which is the monitoring target and flows on the communication line, is consecutively received until the end instruction is received from the user, by repeatedly determining whether or not the packet 8 is received.

In a case where the determining process in step S10 is YES, that is, in a case where the packet 8 is received, the process proceeds to step S30.

In step S30, the calculation unit 10 associates the received packet 8 with time information (referred to as time stamp) in which the packet 8 is received, and stores the result of association in, for example, a predetermined area of the memory 104.

Furthermore, the calculation unit 10 analyzes a header of the received packet 8, and acquires an IP address (referred to as a transmission source address) and a port number (referred to as a transmission source port number) of the transmission terminal which transmits the packet 8. In addition, the calculation unit 10 analyzes the header of the received packet 8, and acquires an IP address (referred to as a transmission destination address) and a port number (referred to as a transmission destination port number) of the reception terminal which is the transmission destination of the packet 8. Furthermore, the calculation unit 10 analyzes the header of the received packet 8, and acquires a protocol which is applied to a transport layer (that is, a layer 4 in an OSI reference model) in a case where the packet 8 is transmitted and received.

In step S40, the calculation unit 10 refers to the session management table 12 which is stored in the predetermined area of the memory 104, and determines whether or not the same session information as the session of the received packet 8 is already registered in the session management table 12.

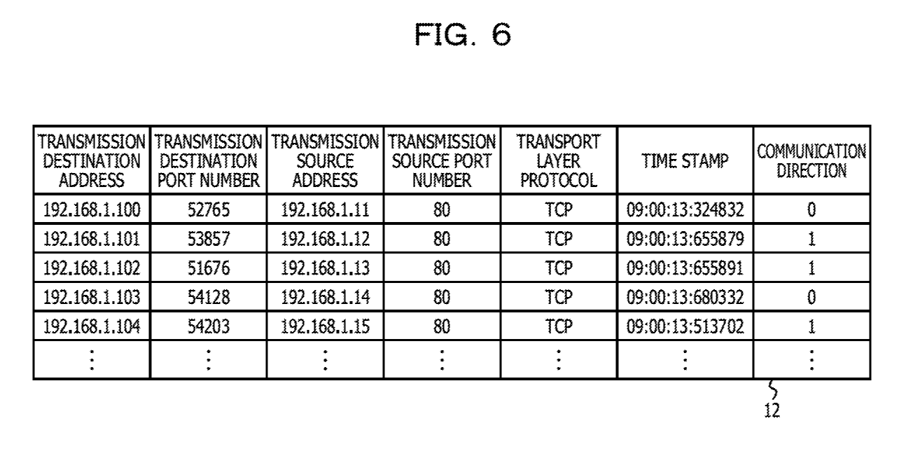

As illustrated in FIG. 6, the session management table 12 is a table in which pieces of information about the transmission destination address, the transmission destination port number, the transmission source address, the transmission source port number, a transport layer protocol, the time stamp, and information relevant to the communication direction are associated with each other in a row direction.

Here, the communication direction is information which indicates the communication direction of the packet 8 in the network 1. For example, the communication direction of the packet 8 which is transmitted from the server 5 toward the client terminal 4 is indicated by “1”, and the communication direction of the packet 8 which is transmitted from the client terminal 4 toward the server 5 is indicated by “0”. Meanwhile, the values of “0” and “1” which indicates the communication directions are an example, and it is apparent that any value may be used if it is possible to specify the communication direction of the packet 8 from information about the communication direction in the session management table 12.

A session is indicated by, for example, a combination of the transmission destination address, the transmission destination port number, the transmission source address, the transmission source port number, and the transport layer protocol, that is, the session information. Accordingly, in a case where the session information of the received packet 8 is already included in any one of row data in the session management table 12, the calculation unit 10 determines that the same session information as the session of the received packet 8 is already registered in the session management table 12. Meanwhile, hereinafter, the row data of the session management table 12 is referred to as session data.

Since the information about the communication direction is included in the session management table 12, it is possible to treat respective pieces of session information, in which the transmission destination address and the transmission destination port number of the packet 8 are interchanged with the transmission source address and the transmission source port number of the packet 8, as one session data. Accordingly, even in a case where the session information, in which the transmission destination address and the transmission destination port number of the packet 8 are interchanged with the transmission source address and the transmission source port number of the packet 8, exists in the session management table 12, the calculation unit 10 determines completion of registration of the session information in the session management table 12.

Meanwhile, the session management table 12 may not include the information about the communication direction in some cases. In such case, respective pieces of session information before and after the transmission destination address and the transmission destination port number of the packet 8 are interchanged with the transmission source address and the transmission source port number of the packet 8 are registered as individual session data in the session management table 12.

However, as illustrated in FIG. 6, in a case where the information about the communication direction is included in the session management table 12, it is possible to reduce the number of rows of the session management table 12, that is, the amount of data, compared to a case where the information about the communication direction is not included in the session management table 12.

In a case where the determination in step S40 is NO, that is, in a case where the same session information as the session of the received packet 8 is not registered in the session management table 12, the process proceeds to step S50.

Meanwhile, time information of the packet 8 which is received last time from the transmission terminal indicated by the session information is registered in the time stamp of the session management table 12.

In step S50, the calculation unit 10 adds the session data, which includes the session information of the received packet 8, to the session management table 12 illustrated in FIG. 6. In this case, the calculation unit 10 uses the time stamp which is associated with the packet 8 in step S30 as the time stamp of the session data to be added.

In addition, the calculation unit 10 sets the communication direction of the session data to be added to the session management table 12 based on, for example, the transmission source address of the packet 8. Specifically, for example, the IP address of each client terminal 4 is stored in the memory 104 in advance. Furthermore, in a case where the transmission source address of the received packet 8 does not coincide with any one of the IP addresses of the client terminals 4, the calculation unit 10 may set the communication direction to “1”. In addition, in a case where the transmission source address of the received packet 8 coincides with any one of the IP addresses of the client terminals 4, the calculation unit 10 may set the communication direction to “0”.

In contrast, in a case where the determination in the determining process in step S40 is YES, that is, the same session information as the session of the received packet 8 is registered in the session management table 12, the process proceeds to step S60.

The packet 8, which is transmitted and received in the network 1, includes ACK or the like which is used as ACK of a data packet in addition to, for example, a packet which includes data added by a transmission terminal in a data section of the packet 8, that is, a packet which is referred to as the data packet.

Accordingly, in step S60, the calculation unit 10 determines whether or not the received packet 8 is the data packet. In a case where the received packet 8 is not the data packet, the process returns to step S10, and a subsequent packet 8 is received. In contrast, in a case where the received packet 8 is the data packet, the process proceeds to step S70.

A reason why it is determined whether or not the received packet 8 is the data packet is to calculate a transmission interval between data packets which are transmitted by the transmission terminal as will be described later. Meanwhile, the calculation unit 10 refers to the data length of the data section which is included in the header of the received packet 8, and determines that the received packet 8 is not the data packet if, for example, a data length of the data section is “0”.

As described above, in step S70, the calculation unit 10 determines the communication direction of the packet 8 based on, for example, the transmission source address of the packet 8. Furthermore, the calculation unit 10 refers to the session data in the session management table 12 which includes the same session information as the session of the packet 8, and determines whether or not the communication direction of the received packet 8 is the same as the communication direction of the session data.

In a case where the communication direction of the received packet 8 is different from the communication direction of a relevant session information of the session management table 12, that is, in a case where the communication direction of the packet 8 is different from the communication direction of a packet 8 which is received last time, the process proceeds to step S120 of FIG. 5B which will be described later.

In contrast, in a case where the communication direction of the packet 8 is the same as the communication direction of the relevant session information of the session management table 12, that is, in a case where the communication direction of the packet 8 is the same as the communication direction of the packet 8 which is received last time, the process proceeds to step S80.

That is, in a case where the server 5 and the client terminal 4 alternately transmit the packet 8 and the communication direction of the received packet 8 is different from the communication direction of the packet, which is received last time, in the same session, processes in steps S80 to S110 which will be described later are not performed. The reason for this is to calculate the transmission interval between the packets 8, which are consecutively transmitted from the same transmission terminal, in step S90 which will be described later.

In step S80, the calculation unit 10 first refers to the packet count table 14.

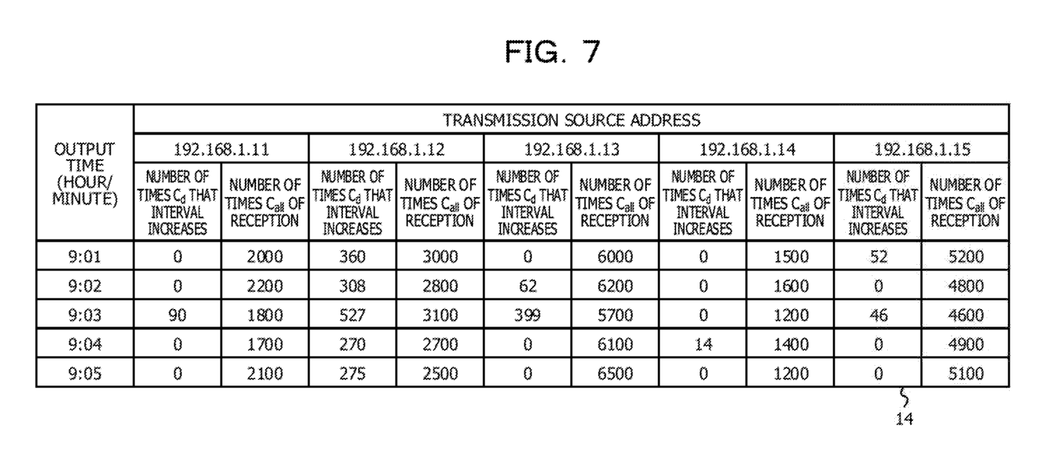

Here, the packet count table 14 will be described with reference to FIG. 7. As illustrated in FIG. 7, the packet count table 14 is, for example, a table in which the number of times Cₐₗₗ that the packet 8 is received and the number of times C_{d} that an interval increases in each output time are counted for each transmission source address of the packet 8.

The output time is a time which, in a case where time is divided into certain periods, is used as an index uniquely indicating the times included in the periods acquired through the division.

For example, an output time “9:01” indicates a period in which time passes nine o'clock and does not reach nine one. An output time “9:02” indicates a period in which time passes nine one and does not reach nine two. Meanwhile, here, an example in which the certain period is set to one minute is described. However, a value which is set to the certain period is not limited and the certain period may be set to a value other than one minute.

The number of times Cₐₗₗ that reception is performed indicates the number of times that the packet 8 is received for each transmission source address in the certain period which is indicated by a relevant output time. The number of times C_{d} that the interval increases indicates the number of times in which an interval between the packet 8, which is received last time, and the packets 8 which are received for respective transmission source addresses in the certain period indicated by the relevant output time is equal to or longer than the predetermined period.

As an example, a value will be described which is included in a field, in which the transmission source address is “192.168.1.11” and the output time is “9:03”, of the packet count table 14 of FIG. 7. In this case, it is indicated that a transmission terminal whose transmission source address is indicated by “192.168.1.11” transmits the packets 8 in the certain period indicated by the output time “9:03” 1800 times, and that a transmission interval between the packets 8 is equal to or longer than a predetermined period in the period 90 times.

Furthermore, the calculation unit 10 increases by one in the packet count table 14 the number of times Cₐₗₗ that the transmission source address of the packet 8 is received in the row data of the output time corresponding to the time stamp of the received packet 8. Hereinafter, the row data indicated by the output time is referred to as “output time data”, and the row data of the output time corresponding to the time stamp of the packet 8 is described as the “output time data of the packet 8”.

Meanwhile, in a case where the output time data of the received packet 8 does not exist in the packet count table 14, the calculation unit 10 adds initialized data, in which all the elements other than the output time are set to “0”, to the packet count table 14. That is, the calculation unit 10 sets the output time corresponding to the time stamp of the received packet 8 to an output time field, and adds the initialized data, in which the number of times Cₐₗₗ that the packet 8 is received and the number of times C_{d} that the interval increases are set to “0”, to the packet count table 14.

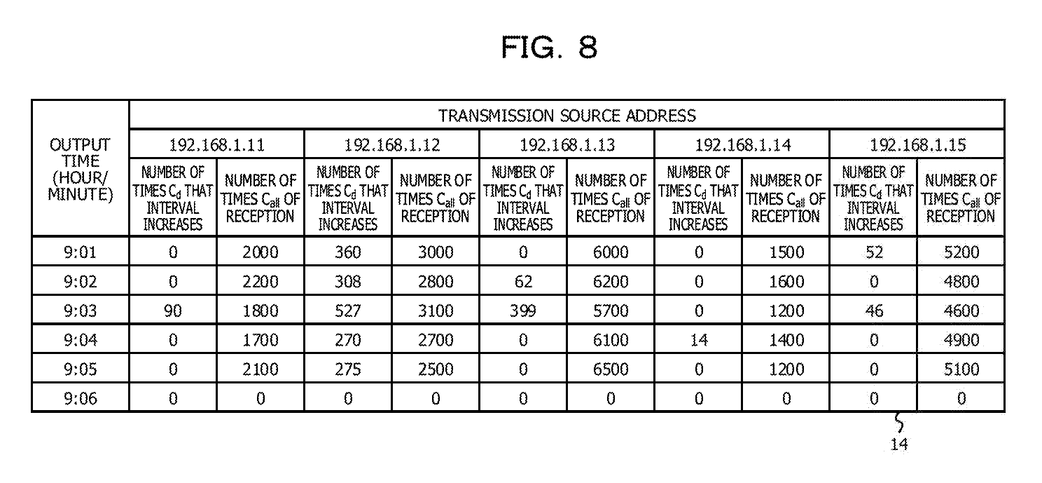

FIG. 8 illustrates an example in which, since the time stamp of the received packet 8 is, for example, “09:05:18”, initialized data whose output time is “9:06” is added to the packet count table 14 in which the output time exists up to “9:05”.

Meanwhile, in a case where the output time to be added to the packet count table 14 is not consecutive to the output time of the packet count table 14 in certain period units, the calculation unit 10 adds the initialized data to the packet count table 14 such that the output time is consecutive in certain period units.

Here, the phrase “is not consecutive to the output time in certain period units” indicates a situation in which, if, for example, the certain period is one minute, an interval between the latest output time which is already recorded in the packet count table 14 and an output time to be added to the packet count table exceeds one minute.

Specifically, in a case where the time stamp of the received packet 8 is, for example, “09:06:18”, the output time corresponding to the received packet 8 is “9:07”. In this case, if the latest output time which is recorded in the packet count table 14 is “9:05”, the interval between the respective output times exceeds the certain period.

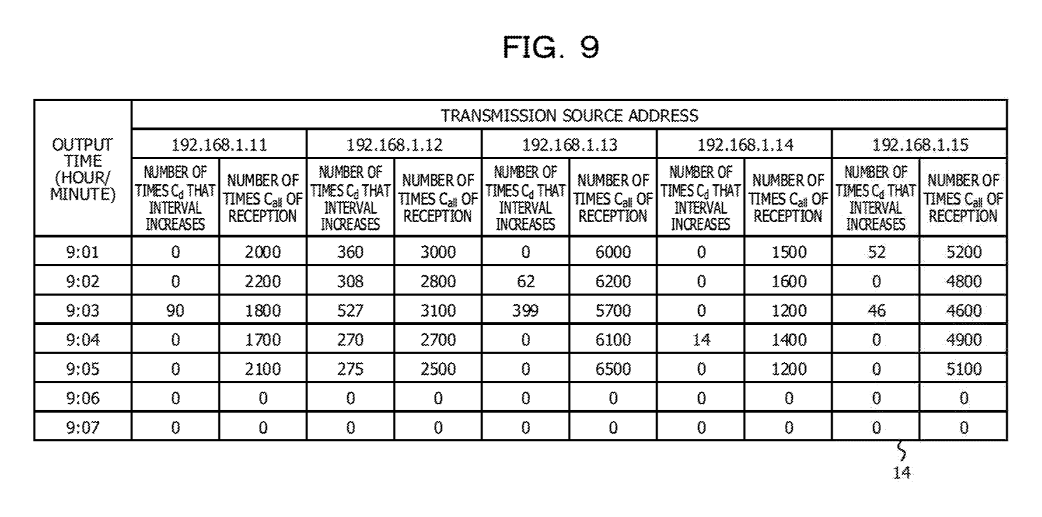

Accordingly, as illustrated in FIG. 9, the calculation unit 10 adds the output time corresponding to the time stamp of the received packet 8, that is, the initialized data in which the output time is “9:07” and the initialized data in which the output time is “9:06” to the packet count table 14. Meanwhile, hereinafter, an “output time corresponding to the time stamp of the packet 8” is referred to as an “output time of the packet 8”.

Moreover, the calculation unit 10 increases by one the number of times Cₐₗₗ that the transmission source address of the packet 8 is received in the output time data of the received packet 8 in the packet count table 14.

In step S90, the calculation unit 10 acquires a time stamp of session data, which includes the same session information as the session of the received packet 8, from the session management table 12 illustrated in FIG. 6. That is, the calculation unit 10 acquires the time stamp of the packet 8 which is received last time from the same transmission terminal as the transmission terminal which transmits the received packet 8.

In contrast, the calculation unit 10 acquires the time stamp of the received packet 8 which is stored in the memory 104 in step S30.

Furthermore, the calculation unit 10 acquires a difference between the time stamp of the packet 8 which is received last time and a time stamp of a packet 8 which is received this time, and calculates the packet interval between the packets 8.

Subsequently, in step S100 of FIG. 5B, the calculation unit 10 determines whether or not the packet interval calculated in step S90 is equal to or larger than a threshold th₁. In a case where the packet interval is equal to or larger than the threshold th₁, the process proceeds to step S110. Otherwise, the process in step S110 is not performed and the process proceeds to step S120.

It is preferable to set the threshold th₁ to a value with which it is possible to assume that a missing packet 8 is retransmitted by the transmission terminal due to missing of the packet 8.

For example, the threshold th₁ may be set to a retransmission time out (RTO) value of the packet 8, which is set to the transmission terminal in advance. Meanwhile, RTO is an ACK waiting time until retransmission of the packet 8 starts.

Furthermore, the threshold th₁ may be set to an RTO value which is sequentially corrected by taking a delay time (round trip time (RTT)) into consideration from when the packet 8 is transmitted by the transmission terminal until ACK for the packet 8 is received from the reception terminal. In this case, compared to a case where the threshold th₁ is set based on RTO in which a value is fixed, it is possible to set the threshold th₁ according to the amount of traffic and a coupling form of the actual network 1.

Meanwhile, the threshold th₁ to be compared with the calculated packet interval is an example of a first threshold in the disclosed technology.

In step S110, the calculation unit 10 increases by one the number of times C_{d} that an interval between the transmission source addresses of the packets 8 increases in the output time data of the received packets 8 in the packet count table 14.

In step S120, the calculation unit 10 determines whether or not the output time of the received packet 8 is a time later than the comparative time which is updated in step S160 which will be described later. In a case where the output time of the received packet 8 is the time later than the comparative time, the process proceeds to step S130. In contrast, in a case where the output time of the received packet 8 is a time previous to the comparative time, the process proceeds to step S170 without performing process in steps S130 to S160.

Meanwhile, as already described, an initial value of the comparative time is set to “0:00” such that the comparative time is a time previous to the output time of the received packet 8.

In step S130, the calculation unit 10 refers to the packet count table 14, and calculates the detection rate r_{d} of the last output time previous to the output time of the received packet 8, that is, an immediately-before output time for each transmission source address.

The detection rate r_{d} for each transmission source address is calculated by Equation (1) using the number of times Cₐₗₗ that the packet 8 is received and the number of times C_{d} that the interval increases in each transmission source address field.

$${r}_{d} = \frac{{C}_{d}}{{C}_{all}} \qquad ( Equation 1 )$$

A reason of calculating the detection rate r_{d} of the immediately-before output time for the output time of the received packet 8 in step S130 is that there is no possibility hereafter that the packet 8 associated with a time stamp included in the certain period corresponding to the immediately-before output time is received. That is, the reason for this is that the output time data of the packet count table 14 in the immediately-before output time is fixed without being changed hereafter. Meanwhile, hereinafter, there is a case where the immediately-before output time of the output time of the packet 8 which is received in step S10 is referred to as a “target output time”.

Meanwhile, in an initial output time of the packet count table 14, that is, an output time in which initially received packet 8 is included, there is a case where it is difficult to count the number of times Cₐₗₗ that the packet 8 is received and the number of times C_{d} that the interval increases through a certain period depending on a reception timing of the packet 8.

For example, in a case where the time stamp of the initially received packet 8 is nine o'clock and forty seconds, the output time data of the output time “9:01” includes only the number of times Cₐₗₗ that the packet 8 is received for 20 seconds until one minute after nine o'clock and the number of times C_{d} that the interval increases. Accordingly, in a case where the target output time is an initial output time of the packet count table 14, the calculation unit 10 may determine whether or not to calculate the detection rate r_{d} in accordance with the setting performed by the user.

In step S140, the calculation unit 10 adds the detection rate r_{d} of the target output time calculated in step S130 to the packet interval increase detection data 16 for each transmission source address. The calculation unit 10 stores the packet interval increase detection data 16, to which the detection rate r_{d} of the target output time is added, in, for example, a predetermined area of the memory 104. Meanwhile, hereinafter, there is a case where the packet interval increase detection data 16 is referred to as “detection data 16”.

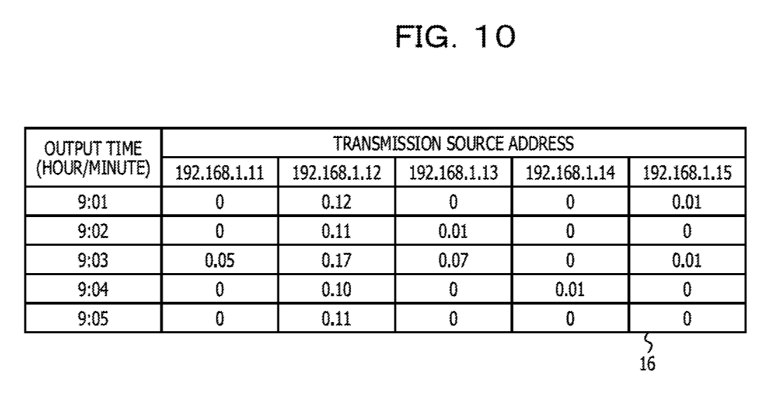

Here, the detection data 16 will be described with reference to FIG. 10. As illustrated in FIG. 10, the detection data 16 is, for example, data in which the detection rate r_{d} of each output time is counted for each transmission source address of the packet 8.

For example, in a case where the target output time is “9:05”, the output time data in which the output time is “9:05” is added to the detection data 16 based on the packet count table 14 illustrated in FIG. 7.

Meanwhile, in a case where the target output time to be added is not consecutive to the latest output time of the detection data 16 in certain period units, the calculation unit 10 adds the initialized data between the target output time and the latest output time such that the output time is consecutive in certain period units.

Specifically, in a case where the target output time is “9:05” and the latest output time recorded in the detection data 16 is “9:03”, the initialized data in which the output time is “9:04” is added to the detection data 16 in addition to the output time data in which the target output time is “9:05”.

In step S150, the determination unit 20 performs a packet loss determining process of determining whether or not packet loss has occurred upstream of the packet analysis apparatus 2 in each output time and for each transmission terminal based on the detection data 16 which is generated in step S140. Meanwhile, the packet loss determining process will be described later in detail.

In step S160, the calculation unit 10 sets the output time of the received packet 8 to the comparative time. That is, the comparative time which is compared with the output time of the received packet 8 in step S120 is sequentially updated by the output time of the received packet 8.

The reason for this is to, in a case where a plurality of packets 8 whose output times are the same are received, avoid the processes in steps S130 to S160 being repeatedly performed due to packets 8 which are received afterwards.

In step S170, the calculation unit 10 updates the time stamp and the communication direction of session data in the session management table 12 which includes the same session information as the session of the received packet 8.

Specifically, the calculation unit 10 sets the time stamp of the session data to time stamp which is associated with the packet 8 in step S30. In addition, the calculation unit 10 sets the communication direction of the session data to the communication direction of the received packet 8. Accordingly, in the time stamp and the communication direction of the session management table 12, pieces of relevant information of the packet 8, which is received immediately before, are recorded for respective session data.

After the process in step S170 is performed, the process returns to step S10 of FIG. 5A again, and subsequent packet 8 is received.

Next, the packet loss determining process in step S150 will be described in detail.

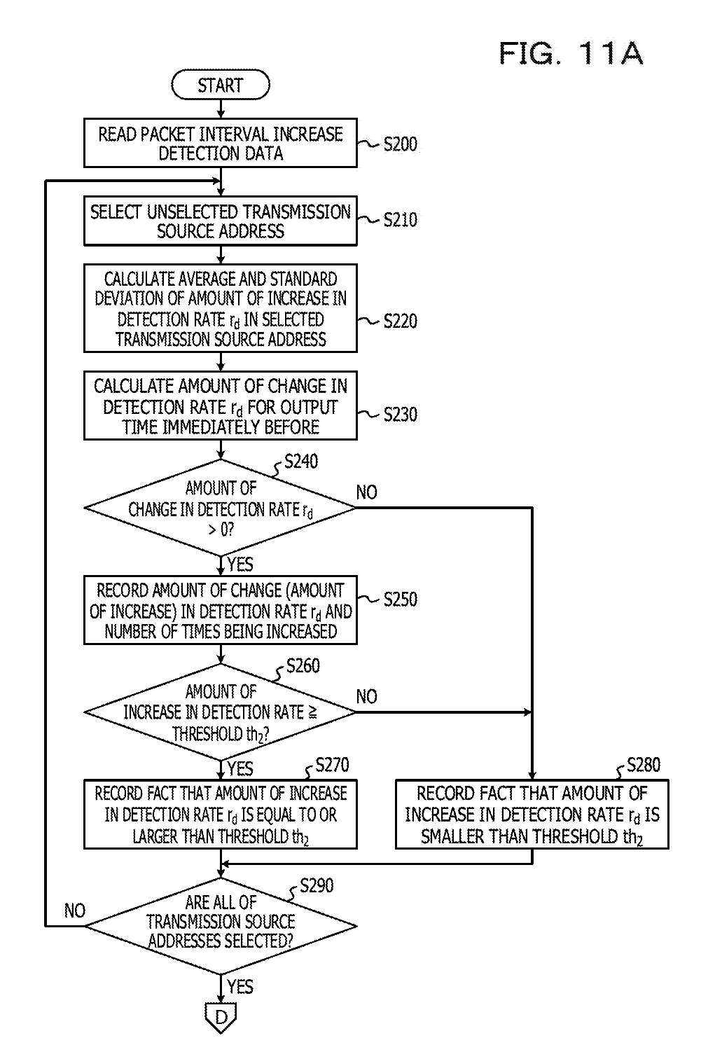

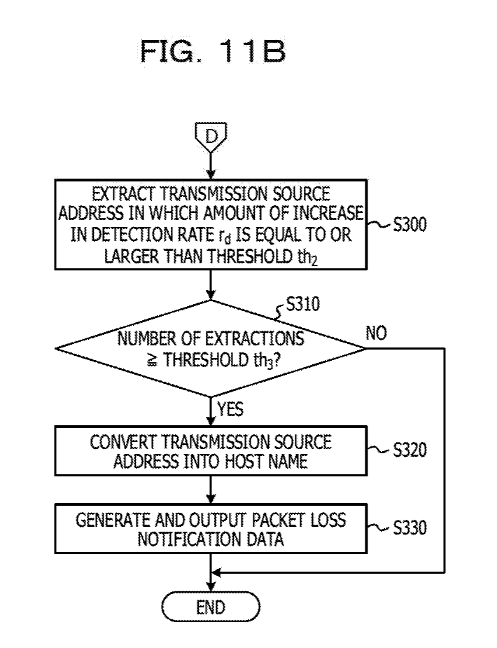

The determination unit 20 performs the packet loss determining process illustrated in FIGS. 11A and 11B in step S150. Meanwhile, hereinafter, there is a case where FIGS. 11A and 11B are collectively referred to as FIG. 11.

First, in step S200 of FIG. 11A, the determination unit 20 reads the detection data 16, which is generated by the calculation unit 10 in step S140 of FIG. 5B, from the memory 104.

In step S210, the determination unit 20 selects one transmission source address, which is not selected yet, among the transmission source addresses which are included in the detection data 16 that is read in step S200.

In step S220, the determination unit 20 calculates an average rₐᵥₑ and a standard deviation r_{std} of the amount of increase in the detection rate r_{d} in the transmission source address selected in step S210 based on content of the increase amount management table 18 that is updated in step S250 which will be described later.

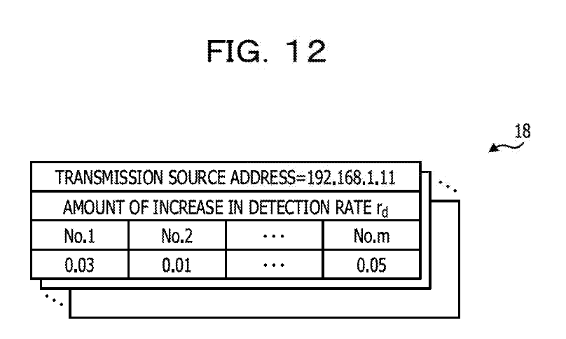

As illustrated in FIG. 12, the increase amount management table 18 exists for each transmission source address, and the increase amount management table 18 is a table in which the amount of increase in the detection rate r_{d} is recorded in a case where the amount of change in the detection rate r_{d} of the immediately-before output time of each output time increases in the detection data 16.

Meanwhile, in an example of the increase amount management table 18 illustrated in FIG. 12, number of No. 1 to No. m (m is a natural value) are individually assigned to the amount of increase in the detection rate r_{d}. However, only the amount of increase in the detection rate r_{d} may be recorded in increase amount management table 18.

In step S230, the determination unit 20 refers to the detection data 16, and calculates the amount of change in the detection rate r_{d} of the target output time for the detection rate r_{d} of the immediately-before output time of the target output time.

In step S240, the determination unit 20 determines whether or not the amount of change in detection rate r_{d}, which is calculated in step S230, is larger than 0, that is, whether or not the amount of change in detection rate r_{d} increases. In a case where the amount of change in detection rate r_{d} increases, the process proceeds to step S250.

In step S250, the determination unit 20 records the amount of change in detection rate r_{d}, which is calculated in step S230, that is, the amount of increase in the detection rate r_{d} in the increase amount management table 18 of the selected transmission source address. Accordingly, in subsequent step S220, it is possible to calculate the average rₐᵥₑ and the standard deviation r_{std} of the amount of increase in the detection rate r_{d} in a form in which the amount of increase in the detection rate r_{d} of the target output time is included.

In step S260, the determination unit 20 determines whether or not the amount of increase in the detection rate r_{d} of the target output time recorded in the increase amount management table 18 in step S250 is equal to or larger than a threshold th₂. In a case where the amount of increase in the detection rate r_{d} is equal to or larger than the threshold th₂, the process proceeds to step S270.

Here, it is preferable that the threshold th₂ is set to a value which is capable of indicating a rapid increase in the amount of increase in the detection rate r_{d}. Specifically, the threshold th₂ is set for each transmission terminal through Equation (2) using the average rₐᵥₑ and the standard deviation r_{std} of the amount of increase in the detection rate r_{d} calculated in step S220.

th₂=rₐᵥₑ+3r_{std} (Equation 2)

In this case, statistically, a probability that the amount of increase in the detection rate r_{d} is equal to or larger than the threshold th₂ is approximately 0.27%. Accordingly, a situation in which the amount of increase in the detection rate r_{d} is equal to or larger than the threshold th₂ is referred to as a situation in which “the amount of increase in the detection rate r_{d} is a rapid increase”.

Meanwhile, Equation (2) is an example in which the threshold th₂ is set, and it is apparent that setting of the threshold th₂ is not limited to Equation (2). In addition, the threshold th₂ is an example of a second threshold of the disclosed technology.

In step S270, the determination unit 20 records a fact that the amount of increase in the detection rate r_{d} of the target output time is equal to or larger than the threshold th₂ in the transmission terminal, which is indicated by the selected transmission source address, in the packet loss count table 22.

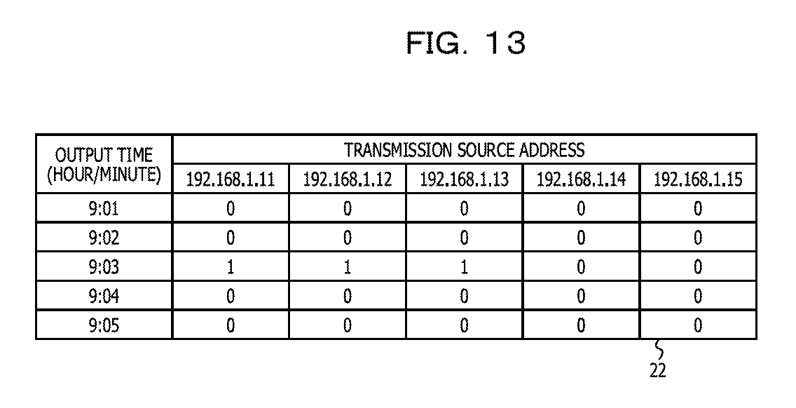

Here, the packet loss count table 22 will be described with reference to FIG. 13. As illustrated in FIG. 13, the packet loss count table 22 is a table in which, for example, the size of the amount of increase in the detection rate r_{d} of each output time is counted for each transmission source address of the packet 8.

For example, “1” is set to a relevant position of the packet loss count table 22 in a case where the amount of increase in the detection rate r_{d} is equal to or larger than the threshold th₂, and “0” is set to a relevant position of the packet loss count table 22 in a case where the amount of increase in the detection rate r_{d} is smaller than the threshold th₂.

Meanwhile, each of the values “0” and “1” is an example which indicates the size of the amount of increase in the detection rate r_{d}, and it is apparent that the size of the amount of increase in the detection rate r_{d} may be indicated by another value.

As an example, notice is taken to a value which is set to a position indicated by the transmission source address “192.168.1.11” and the output time “9:03” in the packet loss count table 22 of FIG. 13. In this case, the value is “1”. Therefore, it is understood that, in the transmission terminal which is indicated by the transmission source address “192.168.1.11”, the amount of increase in the detection rate r_{d} is equal to or larger than the threshold th₂ in a certain period which is indicated by the output time “9:03”, that is, the amount of increase in the detection rate r_{d} rapidly increases.

Meanwhile, in a case where the target output time is not consecutive to the latest output time of the packet loss count table 22 in certain period units, the determination unit 20 adds the initialized data between the target output time and the latest output time such that the output time is consecutive in certain period units.

Specifically, in a case where the target output time to be added to the packet loss count table 22 is “9:05” and the latest output time which is recorded in the packet loss count table 22 is “9:03”, the determination unit 20 adds the initialized data in which the output time is “9:04”.

In contrast, in a case where determination is NO in the determining process in step S240 or S260, the process proceeds to step S280.

In step S280, the determination unit 20 records a fact that the amount of increase in the detection rate r_{d} of the target output time is smaller than the threshold th₂ in the transmission terminal, which is indicated by the selected transmission source address, in the packet loss count table 22.

In step S290, the determination unit 20 determines whether or not all of the transmission source addresses included in the detection data 16 are selected. In a case where there is a transmission source address which is not selected yet among the transmission source addresses included in the detection data 16, the process returns to step S210. Furthermore, the processes in steps S210 to S290 are repeated, and thereby the packet loss count table 22 is acquired where a situation, in which the amount of increase in the detection rate r_{d} rapidly increases in the target output time, is set for each transmission source address.

In a transmission terminal in which the amount of increase in the detection rate r_{d} of a specific output time rapidly increases, it may be considered that there is a high probability that the packet loss has occurred upstream of the packet analysis apparatus 2 in the certain period indicated by the specific output time, compared to the other transmission terminals in which the amount of increase in the detection rate r_{d} of the specific output time does not rapidly increase.

However, there are many cases in which the packet loss has occurred due to failures, increase in the amount of traffic in the network 1, failures of the switch apparatus 3, and cut-off of the communication line, of a system for transmitting the packet 8 in the network 1. In this case, it may be considered that the amount of increase in the detection rate r_{d} rapidly increases at the same time in a plurality of transmission terminals.

Accordingly, it is preferable to determine that packet loss has occurred in a case where the amount of increase in the detection rate r_{d} rapidly increases in the plurality of transmission terminals in the specific output time instead of determining that packet loss has occurred for each transmission terminal based on the situation in which the amount of increase in the detection rate r_{d} rapidly increases.

Therefore, in step S300, the determination unit 20 extracts a transmission source address of a transmission terminal, in which it is determined that the amount of increase in the detection rate r_{d} of the target output time is equal to or larger than the threshold th₂, from the packet loss count table 22. Specifically, the determination unit 20 extracts a transmission source address in which “1” is set to the output time data of the target output time.

In step S310, the determination unit 20 determines whether or not the number of extractions of the transmission source address extracted in step S300 is equal to or larger than a threshold th₃. In a case where the number of extractions of the transmission source address is equal to or larger than the threshold th₃, the process proceeds to step S320.

Here, it is preferable that the threshold th₃ is set to the number of transmission terminals which are expected that the amount of increase in the detection rate r_{d} rapidly increases in a case where, for example, failures occur in the system for transmitting the packet 8 in the network 1. As described above, in this case, it is considered that the amount of increase in the detection rate r_{d} is rapid in the plurality of transmission terminals, and thus the threshold th₃ is set to a value which is equal to or larger than 2. Meanwhile, it is possible to acquire the number of transmission terminals by, for example, actual measurement in the network 1, computer simulation based on design specification of the network 1, or the like.

In a case where the number of extractions of the transmission source address is equal to or larger than the threshold th₃, the determination unit 20 determines that the packet 8 of the transmission terminal, which is indicated by the extracted transmission source address, is missing upstream of the packet analysis apparatus 2, that is, determines that packet loss has occurred.

In step S320, the determination unit 20 converts the respective transmission source addresses included in the packet loss count table 22 into host names, that is, names which are assigned to the transmission terminals corresponding to the transmission source addresses with reference to the address conversion table 24.

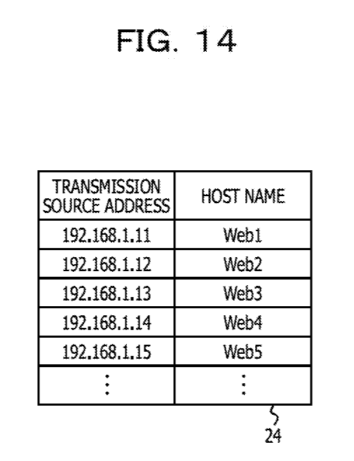

As illustrated in FIG. 14, the address conversion table 24 is a table in which the transmission source addresses are associated with the host names. In an example of the address conversion table illustrated in FIG. 14, a host name “Web1” is associated with a transmission terminal corresponding to a transmission source address “192.168.1.11”, and some host names are associated with transmission terminals corresponding to other transmission source addresses.

In step S330, the determination unit 20 generates the packet loss notification data 26 based on the packet loss count table 22 and the host names acquired in step S320. Specifically, the determination unit 20 acquires the packet loss notification data 26, which was generated last time, from the memory 104, and adds the output time data, which indicates whether or not packet loss has occurred in the respective transmission terminals in the target output time, to the packet loss notification data 26. Here, in a case where the packet loss notification data 26 is not stored in the memory 104, the determination unit 20 newly generates empty packet loss notification data 26, and adds the output time data in the target output time to the packet loss notification data 26.

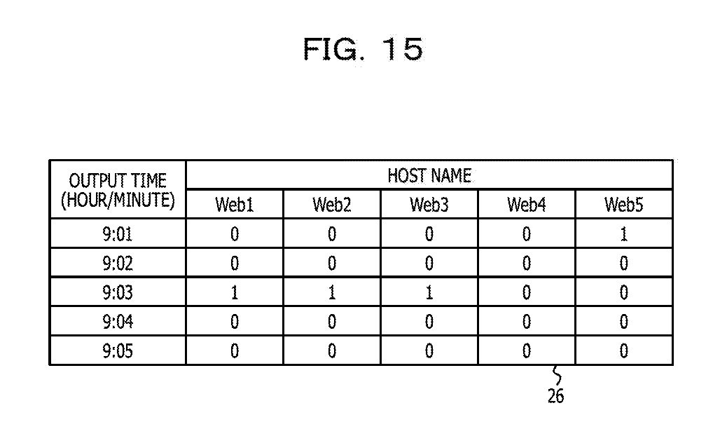

FIG. 15 illustrates an example of the packet loss notification data 26. The determination unit 20 adds output time data, in which, for example, “1” is set to a host name which is determined that packet loss has occurred and “0” is set to a host name in which the occurrence of packet loss is not recognized, to the packet loss notification data 26.

Meanwhile, in a case where the target output time is not consecutive to the latest output time of the packet loss notification data 26 in certain period units, the determination unit 20 adds initialized data between the target output time and the latest output time such that the output time is consecutive in certain period units.

For example, in a case where the target output time is “9:05” and the latest output time recorded in the packet loss notification data 26 is “9:03”, the determination unit 20 also adds initialized data, in which the output time is “9:04”, to the packet loss notification data 26.

The determination unit 20 outputs the generated packet loss notification data 26 to the display device 116, and ends the packet loss determining process illustrated in FIG. 11. In this case, the determination unit 20 stores the generated packet loss notification data 26 in, for example, a predetermined area of the memory 104. Furthermore, the process proceeds to step S160 of FIG. 5B which is described already.

The display device 116 which receives the packet loss notification data 26 displays whether or not packet loss has occurred for each transmission terminal in a form according to time series on a screen of the display device 116 based on content of the packet loss notification data 26.

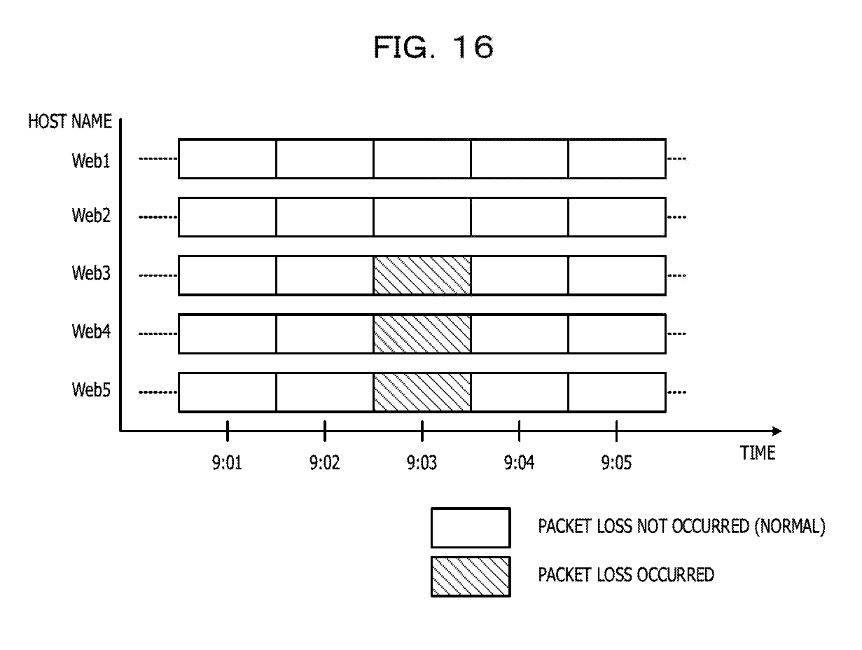

FIG. 16 illustrates an example of a screen which is displayed in the display device 116 based on the packet loss notification data 26 illustrated in FIG. 15.

In the example of the screen of FIG. 16, output times are arranged in time series in a horizontal axis, and the host names of the transmission terminals which transmit the packet 8 are arranged in a vertical axis. The packet loss notification data 26 illustrated in FIG. 15 indicates that packet loss has occurred in Web1, Web2, and Web3 in a period in which the output time is “9:03 and packet loss has not occurred in the other output times. Accordingly, in the example of the screen illustrated in FIG. 16, the same situation relevant to packet loss is illustrated.

In contrast, in a case where the number of extractions of the transmission source address is smaller than the threshold th₃ in step S310, the packet loss determining process illustrated in FIG. 11 ends without performing the processes in steps S320 and S330. The reason for this is that, in a case where the amount of increase in the detection rate r_{d} rapidly increases in transmission terminals corresponding to a number which is smaller than the threshold th₃, it is appropriate to consider that the amount of increase in the detection rate r_{d} rapidly increases due to not packet loss but occurrence of delay of the packet 8 or the like.

As described above, the packet analyzing process illustrated in FIGS. 5A and 5B ends.

In this manner, the packet analysis apparatus 2 according to the first embodiment receives the packet 8, which is the monitoring target and flows through the communication line, until an end instruction of the packet analyzing process is received from the user, and calculates the detection rate r_{d} in each of the transmission terminals in each output time, that is, for each certain period. Furthermore, the packet analysis apparatus 2 calculates the amount of increase in the detection rate r_{d} of consecutive output times. In a case where there are transmission terminals whose amount of increase in the detection rate r_{d} is equal to or larger than the threshold th₂ as many as a number which is equal to or larger than the threshold th₃, the packet analysis apparatus 2 determines that packet loss has occurred in the transmission terminals.

Accordingly, the packet analysis apparatus 2 according to the first embodiment is capable of accurately detecting whether or not packet loss has occurred, compared to a case of detecting a fact that packet loss has occurred upstream of the packet analysis apparatus 2 in a case where the transmission interval between the packets 8 is simply longer than the predetermined interval.

In addition, in the packet analysis apparatus 2 according to the first embodiment, whenever the packet analyzing process of FIG. 5 is performed, the threshold th₂ is set using the average rₐᵥₑ and the standard deviation r_{std} of the amount of increase in the detection rate r_{d}. Accordingly, compared to a case where the threshold th₂ whose value is fixed is used, it is possible to set the threshold th₂ according to the actual packet interval increase situation in the network 1, and thus it is possible to accurately detect packet loss upstream of the packet analysis apparatus 2.

In addition, the packet analysis apparatus 2 according to the first embodiment outputs a result of determination whether or not packet loss has occurred in time series using the packet loss notification data 26. Accordingly, compared to a case where only the latest result of determination relevant to whether or not packet loss has occurred is output, it is possible to supply a tendency of change in packet loss occurrence situation in the network 1 to the user.

Meanwhile, in the packet analysis apparatus 2 according to the first embodiment, the amount of increase in the detection rate r_{d} is compared with the threshold th₂ in step S260 of FIG. 11A. However, for example, the increase rate in the detection rate r_{d} may be compared with the threshold. In this case, in accordance with a fact whether or not the increase rate in the detection rate r_{d} is equal to or larger than a specific threshold, a result of determination thereof is recorded in the packet loss count table 22.

### Second Embodiment

In the packet analysis apparatus 2 according to the first embodiment, it is determined whether or not packet loss has occurred upstream of the packet analysis apparatus 2 based on the number of transmission terminals in which the amount of increase in the detection rate r_{d} is equal to or larger than the threshold th₂.

In a second embodiment, a packet analysis apparatus 2A will be described which determines whether or not packet loss has occurred upstream of the packet analysis apparatus based on a probability of occurrence for the transmission terminals in which the amount of increase in the detection rate r_{d} is equal to or larger than the specific threshold in the same output time.

Meanwhile, a form of a network which is coupled to the packet analysis apparatus 2A according to the second embodiment is the same as the network 1 illustrated in in FIG. 1. In addition, the packet analysis apparatus 2A includes the same components as in the example of the configuration of the packet analysis apparatus 2 illustrated in FIG. 3. Accordingly, an example of configuration, acquired in a case where the packet analysis apparatus 2A is realized by a computer, is the same as in FIG. 4.

Subsequently, an operation of the packet analysis apparatus 2A according to the second embodiment will be described. Similarly to the packet analysis apparatus 2 according to the first embodiment, the packet analysis apparatus 2A performs the packet analyzing process illustrated in FIGS. 5A and 5B in a case where, for example, the analysis start instruction is received from a user through the input device 112.

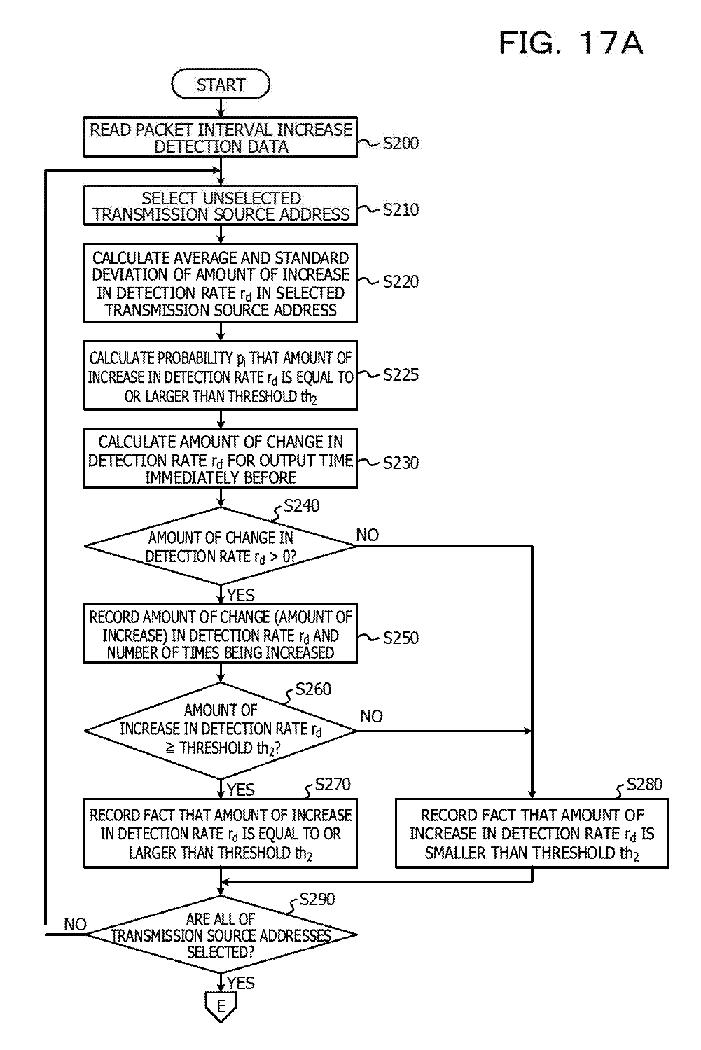

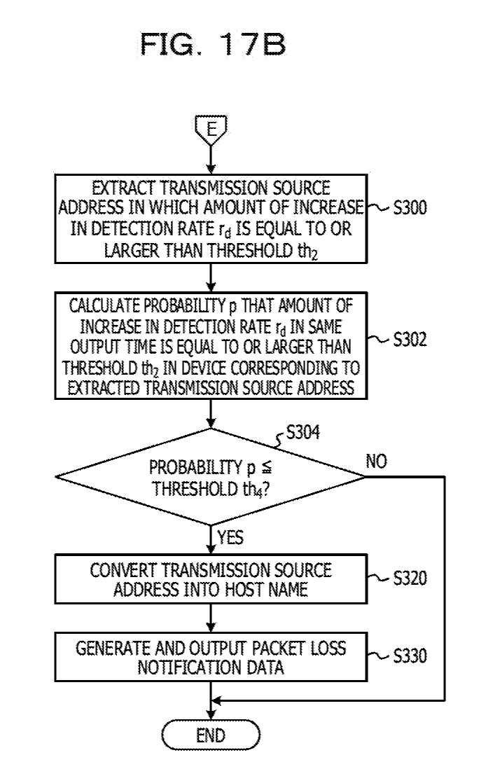

However, in step S150 of FIG. 5B, the packet analysis apparatus 2A performs a packet loss determining process illustrated in FIG. 17 instead of the packet loss determining process illustrated in FIG. 11. Here, FIG. 17 indicates FIG. 17A and FIG. 17B.

The packet loss determining process illustrated in FIG. 17 is different from the packet loss determining process illustrated in FIG. 11 in that steps S225 and S302 are newly added and step S310 of FIG. 11B is replaced by step S304.

In step S225 of FIG. 17A, the determination unit 20 calculates a probability pᵢ that the amount of increase in the detection rate r_{d} is equal to or larger than the threshold th₂ for each transmission source address. Here, a subscript “i” in the probability pᵢ is an index number which identifies a transmission source address recorded in the packet loss count table 22, and, for example, consecutive natural numbers are used.

Specifically, the determination unit 20 refers to the packet loss count table 22, and calculates a ratio of the number of output times whose value is set to “1” to the number of output times recorded in the packet loss count table 22 for each transmission source address. Furthermore, the determination unit 20 sets each ratio to a probability pᵢ in a transmission source address i.

For example, in the packet loss count table 22 illustrated in FIG. 13, index numbers, which are assigned to the respective transmission source addresses including “192.168.1.11” to “192.168.1.15”, are respectively set to “1” to “5”. In this case, probabilities p₁, p₂, and p₃ are respectively set to 0.2, and probabilities p₄ and p₅ are respectively set to 0.

The determination unit 20 stores the calculated probability pᵢ in, for example, the predetermined area of memory 104.

Furthermore, in step S302 of FIG. 17B, the determination unit 20 calculates the probability p in which the amount of increase in the detection rate r_{d} of the same output time is equal to or larger than the threshold th₂ in each of the transmission terminals indicated by the transmission source addresses extracted in step S300.

It is possible to calculate the probability p through multiplication of the probability pᵢ corresponding to the respective transmission source addresses extracted in step S300.

For example, in a case where the transmission source addresses “192.168.1.11” and “192.168.1.12” are extracted in step S300, a probability p₁ corresponding to “192.168.1.11” is the probability p1, and a probability p₁ corresponding to “192.168.1.12” is the probability p2, the probability p is calculated through Equation (3).

$$p = {\prod }_{i = 1}^{2} {ρ}_{i} \qquad ( Equation 3 )$$

In step S304, the determination unit 20 determines whether or not the probability p calculated in step S302 is equal to or smaller than a threshold th₄. In a case where the probability p is equal to or smaller than the threshold th₄, the process proceeds to step S320. Otherwise, the packet loss determining process illustrated in FIG. 17 ends.

Since the probability p is calculated through multiplication of the probability pᵢ for each transmission source address in which the amount of increase in the detection rate r_{d} is the threshold th₂, there is a tendency that a value is small as the number of transmission terminals, in which the amount of increase in the detection rate r_{d} rapidly increases, increases. Accordingly, in a case where, for example, failures occur in the system for transmitting the packet 8 in the network 1, it is preferable to set the threshold th₄ based on the number of transmission terminals, which are assumed that the amount of increase in the detection rate r_{d} rapidly increases, and a standard probability pᵢ of the transmission terminals.

Meanwhile, it is possible to acquire the number of transmission terminals and a value of the standard probability pᵢ in advance through, for example, actual measurement in the network 1 or computer simulation based on the design specification of the network 1.

Accordingly, in a case where the probability p calculated in step S302 is smaller than the threshold th₄, it is possible for the determination unit 20 to determine that the packet 8 of the transmission terminal, which is indicated by the transmission source address extracted instep S300, is missing upstream of the packet analysis apparatus 2.

Hereinafter, similarly to the packet analysis apparatus 2 according to the first embodiment, the determination unit 20 generates the packet loss notification data 26 by performing the processes in steps S320 and step S330, and outputs the generated packet loss notification data 26 to the display device 116.

As described above, in a case where the probability p of existence of the transmission terminals in which the amount of increase in the detection rate r_{d} is equal to or larger than the threshold th₂ in the same output time is equal to or smaller than the threshold th₄, the packet analysis apparatus 2A according to the second embodiment determines that packet loss has occurred in each of the transmission terminals.

Accordingly, even in a case where the number of transmission terminals whose amount of increase in the detection rate r_{d} rapidly increases is smaller than the threshold th₃, it is possible for the packet analysis apparatus 2A to determine that packet loss has occurred upstream of the packet analysis apparatus 2A.

Meanwhile, similarly to the packet analysis apparatus 2 according to the first embodiment, in the packet analysis apparatus 2A, the increase rate in the detection rate r_{d} may be compared with the threshold instead of the amount of increase in the detection rate r_{d} in step S260 of FIG. 17A.

### Third Embodiment

In the packet analysis apparatuses 2 and 2A according to the first embodiment and the second embodiment, it is determined whether or not packet loss has occurred based on the amount of increase in the detection rate r_{d} of the packet 8, in which the packet interval is equal to or larger than the threshold th₁, among packets 8 received in the certain period.

In a third embodiment, a packet analysis apparatus 2B will be described which determines whether or not packet loss has occurred upstream of the packet analysis apparatus based on the detection rate r_{d} instead of the amount of increase in the detection rate r_{d}.

Meanwhile, a form of a network to which the packet analysis apparatus 2B according to the third embodiment is coupled is the same as the network 1 illustrated in FIG. 1.

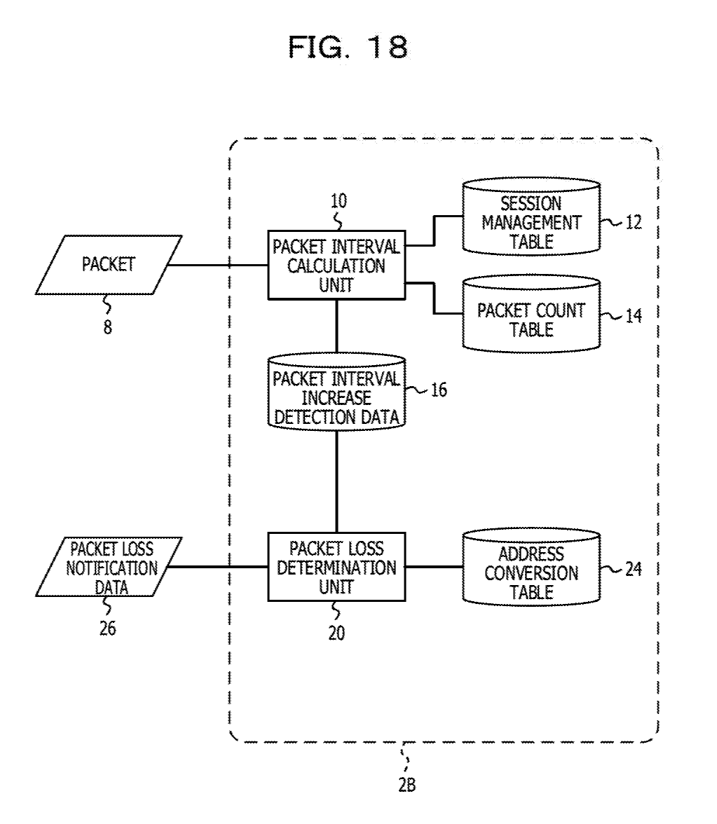

As illustrated in FIG. 18, the packet analysis apparatus 2B includes the packet interval calculation unit 10, the session management table 12, the packet count table 14, the packet interval increase detection data 16, the packet loss determination unit 20, and the address conversion table 24. An example of a configuration of the packet analysis apparatus 2B illustrated in FIG. 18 is different from the examples of the configurations of the packet analysis apparatuses 2 and 2A illustrated in FIG. 3 according to the first embodiment and the second embodiment in that the increase amount management table 18 and the packet loss count table 22 are removed. Meanwhile, an example of a configuration in a case where the packet analysis apparatus 2B is realized by a computer is the same as in FIG. 4.

Subsequently, an operation of the packet analysis apparatus 2B according to the third embodiment will be described. Similarly to the packet analysis apparatus 2 according to the first embodiment, the packet analysis apparatus 2B performs the packet analyzing process illustrated in FIGS. 5A and 5B in a case where the analysis start instruction is received from, for example, the user through the input device 112.

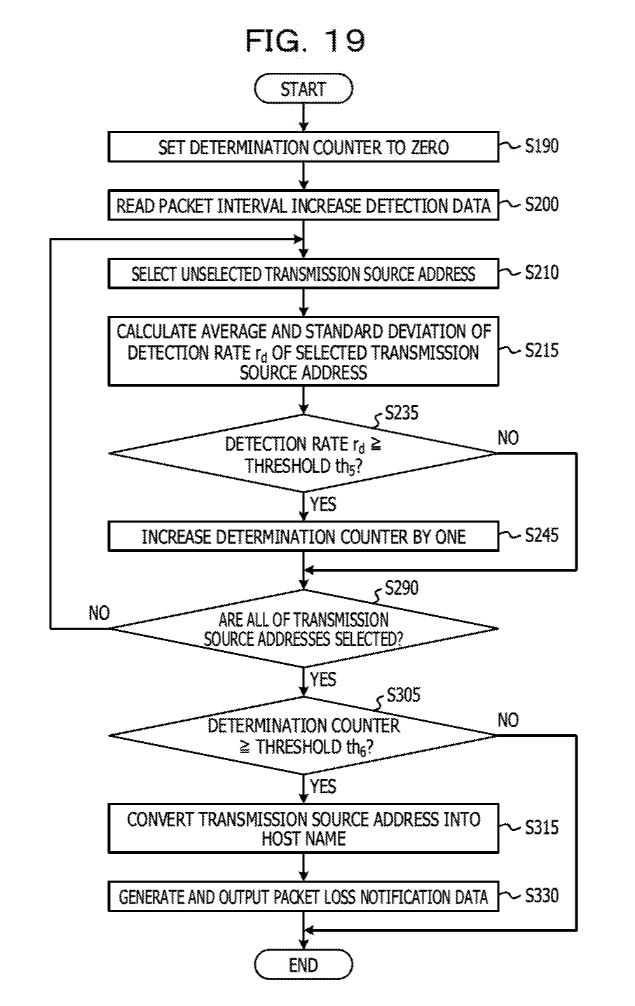

However, the packet analysis apparatus 2B performs a packet loss determining process illustrated in FIG. 19 in step S150 of FIG. 5B instead of the packet loss determining process illustrated in FIG. 11.

First, in step S190, the determination unit 20 initializes, for example, a determination counter value which is stored in the predetermined area of the memory 104 as “0”.

Thereafter, steps S200 and S210 of FIG. 11A which are already described are performed, and thus the determination unit 20 selects one transmission source address which is not selected among the transmission source addresses included in the detection data 16.

In step S215, the determination unit 20 calculates an average hₐᵥₑ and a standard deviation h_{std} of the detection rate r_{d} so far in the transmission source address selected in step S210 based on content of the detection data 16.

In step S235, the determination unit 20 determines whether or not the detection rate r_{d} of the target output time in the transmission source address selected in step S210 is equal to or larger than a threshold th₅ with reference to the detection data 16. In a case where the detection rate r_{d} is equal to or larger than the threshold th₅, the process proceeds to step S245.

Here, it is preferable to set the threshold th₅ to a value which can be considered that detection rate r_{d} rapidly increases. Specifically, similarly to Equation (2) which is an example of calculation of the threshold th₂, the threshold th₅ is set for each transmission terminal as in Equation (4) using the average hₐᵥₑ and the standard deviation h_{std} of the detection rate r_{d} which are calculated in step S215.

th₅=hₐᵥₑ+3h_{std} (Equation 4)

Meanwhile, a situation in which the detection rate r_{d} is equal to or larger than the threshold th₅ is referred to as a situation in which detection rate r_{d} rapidly increases. In addition, it is apparent that Equation (4) is an example of setting the threshold th₅ and the setting of the threshold th₅ is not limited to Equation (4). The threshold th₅ is an example of a second threshold of the disclosed technology.

In step S245, the determination unit 20 increases the determination counter by one.

In contrast, in a case where the detection rate r_{d} is smaller than the threshold th₅ in step S235, the process proceeds to step S290 without performing step S245.

Furthermore, as described above, the determination unit 20 determines whether or not all of the transmission source addresses included in the detection data 16 are selected in step S290, and repeats the processes in step S210 to S290 until all of the transmission source addresses are selected.

Accordingly, the number of transmission terminals, in which the detection rate r_{d} is equal to or larger than the threshold th₅ in the target output time, are recorded in the determination counter.

In step S305, the determination unit 20 determines whether or not the determination counter value is equal to or larger than a threshold th₆. In a case where the determination counter value is equal to or larger than the threshold th₆, the process proceeds to step S315.

Here, it is preferable that the threshold th₆ is set to the number of transmission terminals which are assumed that the detection rate r_{d} rapidly increases in a case where, for example, failures occur in the system for transmitting the packet 8 in the network 1. As described above, in this case, it is considered that the detection rate r_{d} rapidly increases in a plurality of transmission terminal, and thus the threshold th₆ is set to a value which is equal to or larger than 2. Meanwhile, it is possible to acquire the number of transmission terminals in advance through, for example, actual measurement in the network 1 or computer simulation based on the design specification of the network 1.

In a case where the determination counter value is equal to or larger than the threshold th₆, the determination unit 20 determines that packet loss has occurred in the transmission terminals in which the detection rate r_{d} is equal to or larger than the threshold th_{y}.

Accordingly, in step S315, the determination unit 20 refers to the address conversion table 24, and converts the respective transmission source addresses included in the detection data 16 into host names.

Furthermore, the same process as in step S330 of FIG. 11B is performed, and thus the determination unit 20 generates the packet loss notification data 26 and outputs the generated packet loss notification data 26 to the display device 116.

In contrast, in a case where the determination counter value is smaller than the threshold th₆ in step S305, the packet loss determining process illustrated in FIG. 19 ends without performing the processes in steps S315 and S330. The reason for this is that, in a case where the detection rate r_{d} rapidly increases in a number of transmission terminals which is smaller than the threshold th₆, it is appropriate to consider that the detection rate r_{d} rapidly increases due to not packet loss but occurrence of delay of the packet 8 or the like.

As described above, the packet analyzing process illustrated in FIG. 19 ends.

As described above, the packet analysis apparatus 2B according to the third embodiment determines whether or not packet loss has occurred upstream of the packet analysis apparatus 2B based on the number of transmission terminals in which the detection rate r_{d} is equal to or larger than the threshold th₅. In this case, it is not demanded to calculate the amount of increase in the detection rate r_{d} of consecutive output times, and thus it is possible to reduce time for determining packet loss, compared to a case where it is determined whether or not packet loss has occurred based on the amount of increase in the detection rate r_{d}.

### Fourth Embodiment

The packet analysis apparatus 2B according to the third embodiment determines whether or packet loss has occurred upstream of the packet analysis apparatus 2B based on the number of transmission terminals in which the detection rate r_{d} is equal to or larger than the threshold th₅.

In a fourth embodiment, a packet analysis apparatus 2C will be described which determines whether or not packet loss has occurred upstream of the packet analysis apparatus based on a probability of occurrence for transmission terminals in which the detection rate r_{d} is equal to or larger than a specific threshold in the same output time. That is, the fourth embodiment is a modified example of the packet analysis apparatus 2A according to the second embodiment, and a degree of increase in packet interval is evaluated by detection rate r_{d} instead of the amount of increase in the detection rate r_{d}.

Meanwhile, a form of a network to which the packet analysis apparatus 2C according to the fourth embodiment is coupled is the same as the network 1 illustrated in FIG. 1.

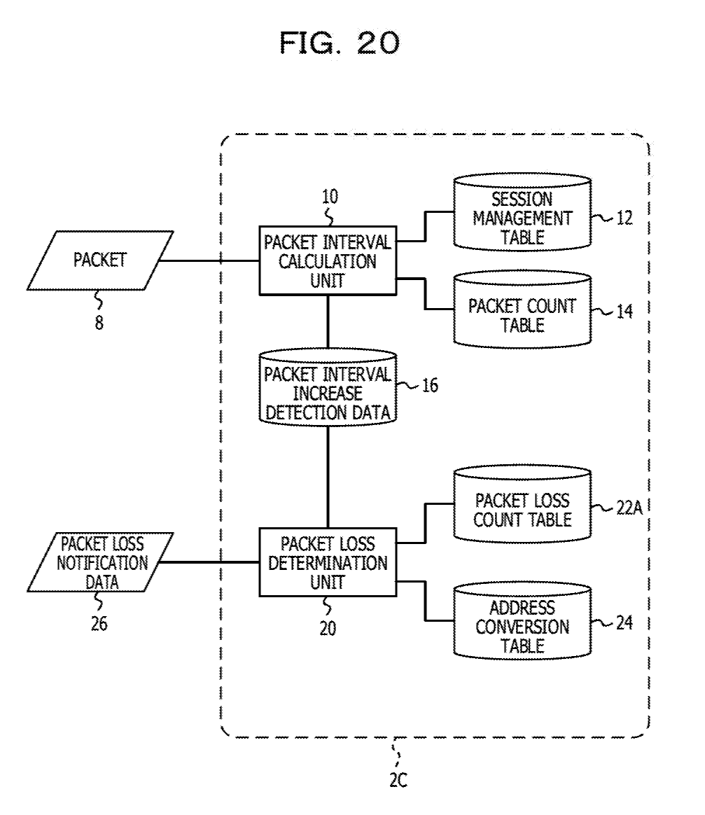

As illustrated in FIG. 20, the packet analysis apparatus 2C includes the packet interval calculation unit 10, the session management table 12, the packet count table 14, and the packet interval increase detection data 16. In addition, the packet analysis apparatus 2C includes the packet loss determination unit 20, a packet loss count table 22A, and the address conversion table 24.

An example of a configuration of the packet analysis apparatus 2C illustrated in FIG. 20 is different from the example of the configuration of the packet analysis apparatuses 2 and 2A according to the first embodiment and the second embodiment illustrated in FIG. 3 in that the increase amount management table 18 is removed. In addition, the packet loss count table 22 of FIG. 3 is replaced by the packet loss count table 22A. The packet loss count table 22A will be described in detail later.

Meanwhile, an example of a configuration in which the packet analysis apparatus 2C is realized by a computer is the same as in FIG. 4.

Subsequently, an operation of the packet analysis apparatus 2C according to the fourth embodiment will be described. Similarly to the packet analysis apparatus 2A according to the second embodiment, the packet analysis apparatus 2C performs the packet analyzing process illustrated in FIGS. 5A and 5B, in a case where, for example, the analysis start instruction is received from the user through the input device 112.

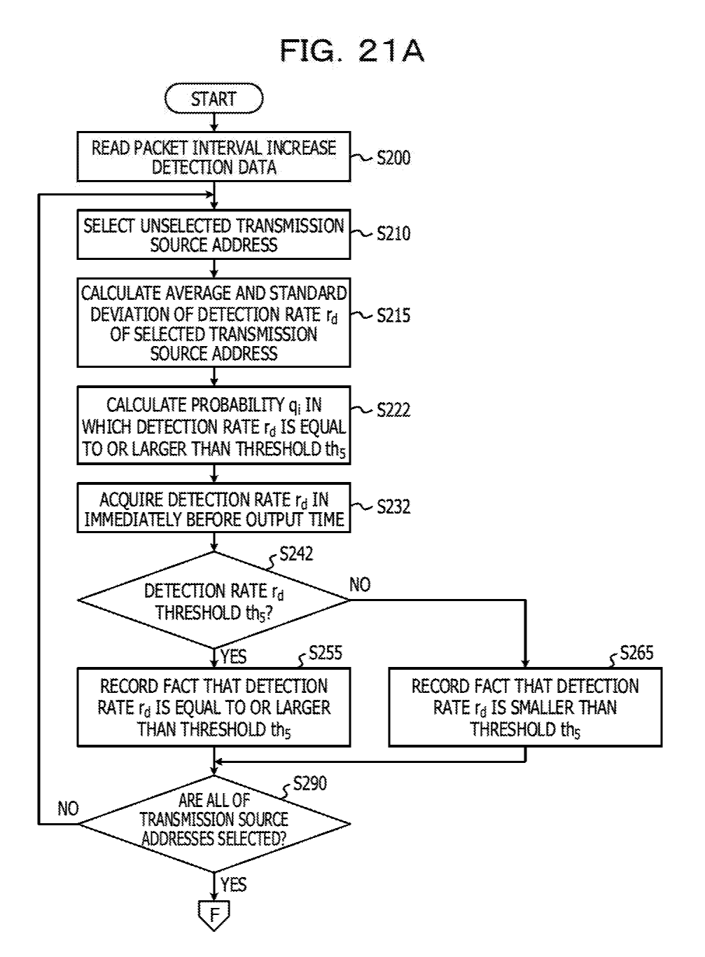

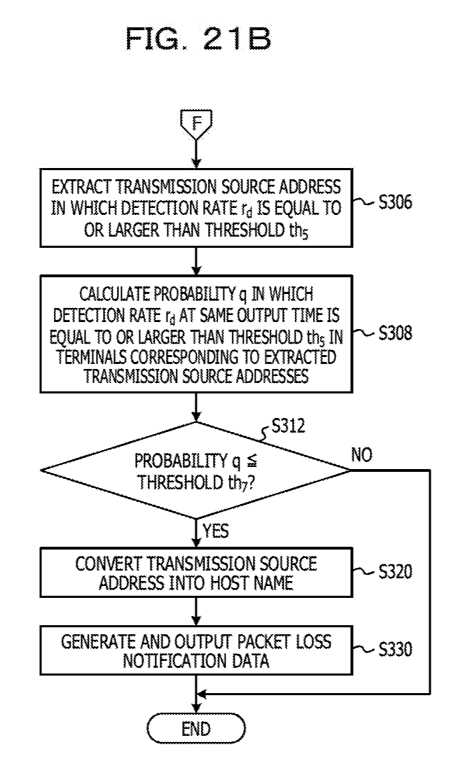

However, the packet analysis apparatus 2C performs a packet loss determining process illustrated in FIG. 21 in step S150 of FIG. 5B instead of the packet loss determining process illustrated in FIG. 17. Here, FIG. 21 indicates FIGS. 21A and 21B.

The packet loss determining process illustrated in FIG. 21 is acquired by replacing a calculation target having a probability which is equal to or larger than the threshold by the detection rate r_{d} instead of the amount of increase in the detection rate r_{d} in the packet loss determining process illustrated in FIG. 17 according to the second embodiment. Accordingly, in FIG. 21, processes of FIG. 17 corresponding to step S240 in which the amount of change in detection rate r_{d} is determined and step S250 in which the amount of increase in the detection rate r_{d} and the number of increases are recorded are removed. In the other steps of FIG. 21, the same or similar processes as in the processes of FIG. 17 are performed.

After step S200 and S210 which are already described are performed, the determination unit 20 calculates an average hₐᵥₑ and a standard deviation h_{std} of the detection rate r_{d} of the transmission source addresses, which are selected in step S210, in step S215.

In step S222, the determination unit 20 calculates a probability qᵢ, in which the detection rate r_{d} is equal to or larger than the threshold th₅, for each transmission source address.

Specifically, the determination unit 20 refers to the detection data 16, and calculates a ratio of output times, in which the detection rate r_{d} is equal to or larger than the threshold th₅, among the respective output times for each transmission source address. Furthermore, each ratio is set to a probability qᵢ of the transmission source address i.

The determination unit 20 stores the calculated probability qᵢ in, for example, a predetermined area of the memory 104.

In step S232, the determination unit 20 refers to the detection data 16, and acquires the detection rate r_{d} of the target output time in the transmission source address selected in step S210.

In step S242, the determination unit 20 determines whether or not the detection rate r_{d} acquired in step S232 is equal to or larger than the threshold th₅. In a case where the detection rate r_{d} is equal to or larger than the threshold th₅, the process proceeds to step S255.

In step S255, the determination unit 20 records a fact that the detection rate r_{d} of the target output time in the transmission terminal, which is indicated by the transmission source address selected in step S210, is equal to or larger than the threshold th₅ in the packet loss count table 22A.

Here, the packet loss count table 22A is, for example, a table in which a size of the detection rate r_{d} of each output time is counted for each transmission source address of the packet 8, and has the same data structure as the packet loss count table 22 illustrated in FIG. 13.

In the packet loss count table 22 illustrated in FIG. 13, “1” is set, in a case where the amount of increase in the detection rate r_{d} is equal to or larger than the threshold th₂, and “0” is set, in a case where the amount of increase in the detection rate r_{d} is smaller than the threshold th₂, to a relevant position of the packet loss count table 22. However, in the packet loss count table 22A, “1” is set, in a case where the detection rate r_{d} is equal to or larger than the threshold th₅, and “0” is set, in a case where the detection rate r_{d} is smaller than the threshold th₅, to a relevant position of the packet loss count table 22A.

Meanwhile, each of the values of “0” and “1” is an example which indicates the size of the detection rate r_{d}, and it is apparent that the size of the detection rate r_{d} may be indicated by other values.

In addition, in a case where the target output time is not consecutive to the latest output time of the packet loss count table 22A in certain period units, the determination unit 20 adds initialized data between the target output time and the latest output time such that the output time is consecutive in certain period units.

In contrast, the determining process in step S242 is NO, the process proceeds to step S265.

In step S265, the determination unit 20 records a fact that the detection rate r_{d} of the target output time in the transmission terminal which is indicated by the transmission source address selected in step S210 is smaller than the threshold th₅ in the packet loss count table 22A.

Furthermore, in step S290, the determination unit 20 determines whether or not all of the transmission source addresses included in the detection data 16 are selected, and repeats the processes in steps S210 to S290 until all of the transmission source addresses are selected.

Accordingly, the output time data of the target output time in the packet loss count table 22A, “0” or “1” is set to all of the transmission source addresses.

In step S306, the determination unit 20 extracts a transmission source address of a transmission terminal, which is determined that the detection rate r_{d} of the target output time is equal to or larger than the threshold th₅, form the packet loss count table 22A.

In step S308, the determination unit 20 calculates a probability q in which the detection rate r_{d} is equal to or larger than the threshold th₅ in the same output time in each of the transmission terminals indicated by the transmission source addresses extracted in step S306.

It is possible to calculate the probability q through multiplication of the probability qᵢ corresponding to the respective transmission source addresses extracted in step S306.

In step S312, the determination unit 20 determines whether or not the probability q calculated in step S308 is equal to or smaller than a threshold th₇. In a case where the probability q is equal to or smaller than the threshold th₇, the process proceeds to step S320. Otherwise, the packet loss determining process illustrated in FIG. 21 ends.

Similarly to the probability p, there is a tendency that a value of the probability q is small as the number of transmission terminals, in which the detection rate r_{d} rapidly increases, increases.

Accordingly, in a case where, for example, failures occur in the system for transmitting the packet 8 in the network 1, it is preferable to set the threshold th₇ based on the number of transmission terminals, which are assumed that the detection rate r_{d} rapidly increases, and a standard probability qᵢ of the transmission terminals. Meanwhile, it is possible to acquire the number of transmission terminals and a value of the probability qᵢ in advance through, for example, actual measurement in the network 1 or computer simulation based on the design specification of the network 1.

Accordingly, in a case where the probability q calculated in step S308 is equal to or smaller than the threshold th₇, it is possible for the determination unit 20 to determine that the packet 8 of the transmission terminal indicated by the transmission source address extracted in step S306 is missing upstream of the packet analysis apparatus 2C.

Hereinafter, similarly to the packet analysis apparatus 2A according to the second embodiment, the determination unit 20 generates the packet loss notification data 26 by performing the processes in steps S320 and S330, and outputs the generated packet loss notification data 26 to the display device 116.

As described above, in a case where the probability q, in which there are transmission terminals whose detection rate r_{d} is equal to or larger than the threshold th₅ in the same output time, is equal to or smaller than the threshold th₇, the packet analysis apparatus 2C according to the fourth embodiment determines that packet loss has occurred in each of the transmission terminals.

Accordingly, the packet analysis apparatus 2C is not desired to calculate the amount of increase in the detection rate r_{d} of consecutive output times. In addition, even in a case where the number of transmission terminals whose detection rate r_{d} rapidly increases is smaller than the threshold th₆, it is possible for the packet analysis apparatus 2C to determine that packet loss has occurred upstream of the packet analysis apparatus 2C.

Meanwhile, in the packet analysis apparatuses 2, 2A, 2B, and 2C (hereinafter, referred to as the packet analysis apparatus 2 and the like) according to the respective embodiments which are described above, an example, in which the packet analyzing process illustrated in FIG. 5 is performed whenever the packet 8 is received, is illustrated. However, a moment in which the packet analyzing process is performed by the packet analysis apparatus 2 and the like is not limited thereto.

For example, the packet analysis apparatus 2 and the like receives the packets 8 during a period from when an instruction to start receiving the packet 8 is received from the user to when an end instruction is received, and stores the received packets 8 in the predetermined area of the memory 104. In this case, the packet analysis apparatus 2 and the like associates time stamps with the received packets 8, respectively, and stores association results in the memory 104.

Furthermore, in a case where the analysis start instruction is received from the user, the packet analysis apparatus 2 and the like acquires the stored packets 8 from the memory 104 in order of old time stamp one by one, and may perform the packet analyzing process illustrated in FIG. 5.

In addition, the packet analysis apparatus 2 and the like determines whether or not packet loss has occurred upstream of the packet analysis apparatus 2 and the like using a value based on the detection rate r_{d} instead of the number of times C_{d} that the interval between the packets 8 increases in the packet count table 14 illustrated in FIG. 7. The value based on the detection rate r_{d} includes, for example, the amount of increase in the detection rate r_{d}, the increase rate in the detection rate r_{d}, the detection rate r_{d}, and the like.

In a case where whether or not the packet loss has occurred is determined using the number of times C_{d} that the interval between the packets 8 increases, a tendency is seen that a transmission terminal which transmits a larger number of packets 8 in a specific output time has an increasing number of times C_{d} that the interval between the packets 8 increases. Accordingly, the number of times C_{d} that the interval between the packets 8 increases is influenced by a frequency in which the packet 8 is transmitted by the transmission terminal, and thus it is difficult to determine whether or not packet loss has occurred upstream of the packet analysis apparatus 2 and the like using the number of times C_{d} that the interval between the packets 8 increases.

Meanwhile, such a situation occurs in the same manner in a case of using a value based on the number of times C_{d} that the interval between the packets 8 increases, for example, the amount of increase in the number of times C_{d} that the interval between the packets 8 increases or the increase rate of the number of times C_{d} that the interval increases.

In addition, the packet analysis apparatus 2 and the like may transmit the packet loss notification data 26 to, for example, another terminal, such as a computer which is coupled to the network 1, and may display an example of a screen based on the packet loss notification data 26 as illustrated in FIG. 16 to another terminal.

In addition, as illustrated in FIG. 2, the packet analysis apparatus 2 and the like may select a communication line which monitors transmission and reception of packets by selecting a port which performs monitoring using the mirroring function of the switch apparatus 3. Accordingly, the packet count table 14, the packet interval increase detection data 16, the increase amount management table 18, the packet loss count tables 22 and 22A, and the packet loss notification data 26 are managed for each communication line which monitors the transmission and reception of the packets.

In addition, it is possible to apply various modifications to a setting method relevant to the output time. For example, the output times of the packet count table 14, the packet interval increase detection data 16, the packet loss count tables 22 and 22A, and the packet loss notification data 26 are indicated by hours and minutes as an example, years, month, and dates may be added. In addition, the output time may be indicated by years, month, dates, hours, minutes, and seconds. In this case, the packet count table 14, the detection data 16, the packet loss count tables 22 and 22A, and the packet loss notification data 26 is not desired to be prepared for each date.

In addition, in a case where the output time is set in second units, for example, the output time may be set from a time in which the packet 8 is received without setting convenient time, such as nine o'clock to a setting time. For example, if a certain interval is one minute and the time in which the packet 8 is received is at nine and twenty-one seconds, the output time may be set as “9:00:21”, “9:01:21”, “9:02:21”, . . . .

Hereinabove, although the disclosed technology is described using the respective embodiments, the disclosed technology is not limited to scopes described in the respective embodiments. Various modifications and improvements of the respective embodiments are possible without departing from the gist of the disclosed technology, and embodiments to which the modifications and improvements are added are also included in the technical scope of the disclosed technology. For example, the sequence of the processes may be changed without departing from the gist of the disclosed technology.

In addition, in the respective embodiments, a form in which the packet analysis program 120 is stored (installed) in advance in the storage unit 106 is described, the disclosed technology is not limited thereto. It is possible to provide the packet analysis program according to the disclosed technology in a form in which the packet analysis program is recorded in the computer-readable recording medium 118. For example, it is possible to provide the packet analysis program according to the disclosed technology in a form in which the packet analysis program is recorded in a portable recording medium such as a CD-ROM, a DVD-ROM or a USB memory. In addition, it is possible to provide the packet analysis program according to the disclosed technology in a form in which the packet analysis program is recorded in a semiconductor memory, such as a flash memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of analyzing packets performed by a computer, the method comprising:
for each of a plurality of data transmission apparatuses and for each of a plurality of periods, specifying a number of packets transmitted from each of the plurality of data transmission apparatuses;
for each of the plurality of data transmission apparatuses and for each of the plurality of periods, specifying a number of times that a transmission interval of the packets is equal to or larger than a first value;
for each of the plurality of data transmission apparatuses and for each of the plurality of periods, specifying a ratio of the number of times to the number of packets;
for each of the plurality of data transmission apparatuses and for each of the plurality of periods, specifying amount of increase of the ratio for a period immediately before each of the plurality of periods;
specifying a period in which the number of the data transmission apparatuses of which the amount of increase is equal to or larger than a second value is equal to or larger than a third value among the plurality of periods; and
outputting first information indicating the specified period.

2. The method according to claim 1, further comprising:
setting the second value based on an average of the amount of increase of the ratio and a standard deviation of the amount of increase of the ratio.

3. The method according to claim 1, wherein the amount of increase of the ratio is an increasing rate of the ratio.

4. The method according to claim 1, further comprising:
outputting, in time series, second information indicating whether the packets transmitted from each of the plurality of data transmission apparatuses are missing.

5. The method according to claim 1, further comprising:
setting the first value for each of the plurality of data transmission apparatuses based on a retransmission start time until each of the plurality of data transmission apparatuses retransmits the packets.

6. The method according to claim 1, further comprising:
outputting third information specifying each of the plurality of data transmission apparatuses.

7. The method according to claim 1, further comprising:
storing the packets transmitted from each of the plurality of data transmission apparatuses in a storage device of the computer; and
specifying the ratio for each of the plurality of data transmission apparatuses and for each of the plurality of periods using the packets stored in the storage device.

8. A method of analyzing packets performed by a computer, the method comprising:
for each of a plurality of data transmission apparatuses and for each of a plurality of periods, specifying a number of packets transmitted from each of the plurality of data transmission apparatuses;
for each of the plurality of data transmission apparatuses and for each of the plurality of periods, specifying a number of times that a transmission interval of the packets is equal to or larger than a first value;
for each of the plurality of data transmission apparatuses and for each of the plurality of periods, specifying a first ratio of the number of times to the number of packets;
for each of the plurality of data transmission apparatuses and for each of the plurality of periods, specifying amount of increase of the first ratio for a period immediately before each of the plurality of periods;
for each of the plurality of data transmission apparatuses, specifying a second ratio of a number of periods in which the amount of increase is equal to or larger than a second value to the number of the plurality of periods;
for each of the plurality of periods, specifying the data transmission apparatuses in which the amount of increase of the first ratio is equal to or larger than the second value, from the plurality of data transmission apparatuses;
specifying a period, in which a value acquired by mutually multiplying the second ratio of the specified data transmission apparatuses is equal to or smaller than a third value, among the plurality of periods; and
outputting first information indicating the specified period.

9. The method according to claim 8, further comprising:
setting the second value based on an average of the amount of increase of the first ratio and a standard deviation of the amount of increase of the first ratio.

10. The method according to claim 8, wherein the amount of increase of the first ratio is an increasing rate of the first ratio.

11. The method according to claim 8, further comprising:
outputting, in time series, second information indicating whether the packets transmitted from each of the plurality of data transmission apparatuses are missing.

12. The method according to claim 8, further comprising:
setting the first value for each of the plurality of data transmission apparatuses based on a retransmission start time until each of the plurality of data transmission apparatuses retransmits the packets.

13. The method according to claim 8, further comprising:
outputting third information specifying each of the plurality of data transmission apparatuses.

14. The method according to claim 8, further comprising:
storing the packets transmitted from each of the plurality of data transmission apparatuses in a storage device of the computer; and
specifying the first ratio for each of the plurality of data transmission apparatuses and for each of the plurality of periods using the packets stored in the storage device.

15. An analysis device comprising:
a memory; and
a processor coupled to the memory and configured to:
for each of a plurality of data transmission apparatuses and for each of a plurality of periods, specify a number of packets transmitted from each of the plurality of data transmission apparatuses,
for each of the plurality of data transmission apparatuses and for each of the plurality of periods, specify a number of times that a transmission interval of the packets is equal to or larger than a first value,
for each of the plurality of data transmission apparatuses and for each of the plurality of periods, specify a ratio of the number of times to the number of packets,
for each of the plurality of data transmission apparatuses and for each of the plurality of periods, specify amount of increase of the ratio for a period immediately before each of the plurality of periods,
specify a period in which the number of the data transmission apparatuses of which the amount of increase is equal to or larger than a second value is equal to or larger than a third value among the plurality of periods, and
output first information indicating the specified period.

16. The analysis device according to claim 15, wherein
the processor is further configured to set the second value based on an average of the amount of increase of the ratio and a standard deviation of the amount of increase of the ratio.

17. The analysis device according to claim 15, wherein
the amount of increase of the ratio is an increasing rate of the ratio.

18. The analysis device according to claim 15, wherein
the processor is further configured to output, in time series, second information indicating whether the packets transmitted from each of the plurality of data transmission apparatuses are missing.

19. The analysis device according to claim 15, wherein
the processor is further configured to set the first value for each of the plurality of data transmission apparatuses based on a retransmission start time until each of the plurality of data transmission apparatuses retransmits the packets.

20. The analysis device according to claim 15, wherein
the processor is further configured to output third information specifying each of the plurality of data transmission apparatuses.
